(19) United States
(12) Patent Application Publication
(10) Pub. No.: US 2013/0236153 A1
(43) Pub. Date: Sep. 12, 2013

(54) METHOD OF MANUFACTURING OPTICAL FIBERS, TAPERED OPTICAL FIBERS AND DEVICES THEREOF

(71) Applicants: Martin Rochette, Montreal (CA); Chams Baker, Montreal (CA)

(72) Inventors: Martin Rochette, Montreal (CA); Chams Baker, Montreal (CA)

(73) Assignee: The Royal Institution for the Advancement of Learning / McGill University, Montreal (CA)

(21) Appl. No.: 13/412,986

(22) Filed: Mar. 6, 2012

(51) Int. Cl. G02B 6/10; B26D 3/10; B23P 17/04; G06F 17/50

(52) U.S. Cl. 385/146; 703/1; 83/13; 29/592

(57) ABSTRACT

Optical fibers and optical fiber tapers have application within many optical systems and optical devices. To date manufacturing such fibers and fiber tapers has been restricted to drawing constant diameter fibers in gravity driven processes and symmetric tapers through pulling with localized heating. However, it would be beneficial to be able to generate arbitrary profiles when pulling an optical fiber into a fiber taper allowing an initial uniform section, reducing transition, wire section, increasing transition and final uniform section. Further, the technique further allows novel optical fiber geometries to be fabricated, which the inventors refer to a hybrid tapers wherein additional elements such as coatings, which provide mechanical and environment protection, may be incorporated into the initial preform and processed simultaneously with the fabrication of the optical taper such that the final fabricated hybrid tapers are mechanically robust and handlable thereby improving manufacturing yield and reducing cost.

### FIELD OF THE INVENTION

This invention relates to optical fibers and more specifically to methods of manufacturing optical fibers and tapered optical fibers.

### BACKGROUND OF THE INVENTION

Optical fiber communications have evolved in the past forty years since the first commercially viable, long length, low attenuation optical fibers in 1970, from Corning Glass Works based upon the fundamental understanding of impurities by STC Laboratories in 1966, to become the ubiquitous solution for telecommunications companies to transmit telephone signals, Internet communication, and cable television signals from high volume, low cost, short-haul applications within Local Area Networks and Passive Optical Networks, such as Fiber-to-the-Home, through to highly engineered ultra-long haul transoceanic links that form an intercontinental network of over 250,000 km of submarine communications cable that by the mid-2000s offered a capacity of 2.56 Tb/s and has increased continuously since.

First generation 45 Mb/s 0.8 μm transmission systems exploiting GaAs semiconductor lasers achieved repeater spacing of up to 10 km. Second generation fiber-optic communication systems operated at 1.3 μm using InGaAsP semiconductor lasers and were initially limited by multi-mode fiber dispersion, until high quality single-mode fibers triggered a capacity and range improvement to systems operating at up to 1.7 Gb/s with repeater spacing up to 50 km. Migration to the lower loss 1.55 μm window of silica fiber was initially hampered by pulse-spreading through the use of conventional InGaAsP semiconductor lasers. However, the development of dispersion-shifted fibers designed to have minimal dispersion at 1.55 μm and single longitudinal mode lasers allowed third-generation systems to operate commercially at 2.5 Gbit/s with repeater spacing in excess of 100 km.

Fourth generation fiber-optic communication systems exploited optical amplification to reduce the need for repeaters and wavelength-division multiplexing to increase data capacity. These two improvements resulted in the doubling of system capacity every 6 months for nearly a decade in the 1990s until a bit rate of 10 Tb/s was reached by 2001 for repeater spacing 100 km to 150 km. Fifth generation fiber-optic communications focused on extending the wavelength range over which WDM systems operated by extending the conventional wavelength window, known as the C band, covers the wavelength range 1.53-1.57 μm, as “dry fiber” has a low-loss window between 1.30-1.65 μm. Other developments including optical solutions emerged allowing transmitted optical pulses to preserve their shape by counteracting the effects of dispersion with the nonlinear effects of the fiber by using pulses of a specific shape.

During this period engineers and scientists have repeatedly battled, conquered, re-encountered, and harnessed non-linear effects in optical fiber as one of unique characteristics of silica optical fibers is their relatively low threshold for nonlinear effects. This can be a serious disadvantage in optical communications, especially in wavelength-division multiplexing (WDM) systems, where many closely spaced channels propagate simultaneously, resulting in high optical intensities in the fiber. For instance, in a typical commercial 128-channel 10-Gb system, optical nonlinearities limit the power per channel to approximately −5 dBm for a total launched power of 16 dBm. Beyond this power level, optical nonlinearities can significantly degrade the information capacity of the system.

On the other hand, optical nonlinearities can be very useful for a number of applications, starting with distributed in-fiber amplification and extending to many other functions, such as wavelength conversion, multiplexing and demultiplexing, pulse regeneration, optical monitoring, and switching. In fact, the development of the next generation of optical communication networks is likely to rely strongly on fiber nonlinearities in order to implement all-optical functionalities. The realization of these new networks will therefore require that one look at the tradeoff between the advantages and disadvantages of nonlinear effects in order to utilize their potential to the fullest.

Interest in nonlinear fiber optics developed with the rapid growth of optical-fiber communications in the early 1980s and has been strong for the past 25 years. Over that period, in excess of ten thousand journal articles and conference papers have been published on the subject, several subfields have also developed and each of them has become very specialized. Amongst these are new glasses and fiber geometries with the intention of providing highly nonlinear fibers (HNLFs) and, in particular, micro-structured fibers. These HNLFs provide different fiber parameters that are related to both the material or glass composition and fiber geometry and the interplay between the two.

Why are optical nonlinearities of such prominence in research and development for sixth and subsequent generations of fiber optic devices and communication systems? Despite the small nonlinear index of silica (n₂=2.6×10⁻¹⁶ cm² W⁻¹), there are two characteristics of the optical fiber that strongly enhance optical nonlinearities: the core size and the length of the fiber. It is easy to show that the nonlinearities in bulk and silica fibers, respectively, are in the ratio provided by Equation (1) below.

$$\frac{{I}_{f} {L}_{eff} ( fiber )}{{I}_{b} {L}_{eff} ( bulk )} = \frac{λ}{π {r}_{0}^{2} α} \qquad ( 1 )$$

where I_{f,b} is the intensity (power per p for nonlinear effects, fibers are often fabricated with λ_{ZDW} near 1550 nm. This wavelength is also close to the maximum gain of erbium doped fiber amplifiers (EDFA) at 1530 nm.

Generally, two different types of nonlinearities are differentiated:
Type 1) the nonlinearities that arise from scattering, such as stimulated Brillouin scattering (SBS) and stimulated Raman scattering (SRS) for example; and
Type 2) the nonlinearities that arise from optically induced changes in the refractive index, and result either in phase modulation, such as self-phase modulation (SPM) and cross-phase modulation (XPM) for example, or in the mixing of several waves and the generation of new frequencies, such as modulation instability (MI) for example, and parametric processes, such as four-wave mixing (FWM) for example.

An example of how optical fiber non-linearities can be viewed on the one hand as disadvantageous and on the other hand as advantageous is XPM. Within WDM systems XPM leads to interchannel crosstalk and can also produce amplitude and timing jitter. However, it can be exploited in non-linear pulse compression (to over chromatic dispersion in the optical fiber), passive mode-locking of ultrafast optical sources, ultrafast all-optical switching, demultiplexing optical time division multiplexing, parametric amplification, and wavelength conversion for all-optical wavelength switching of WDM channels. Non-linearities are also exploited in other devices such as supercontinuum sources which in conjunction with optical slicing techniques offer extremely high channel counts, up to 1,000 channels being reported for example in the prior art.

However, as noted above these optical fiber non-linearities are evident in very long optical fiber communication systems with or without optical amplifiers operating at multi-gigabit rates of lengths of kilometers to tens of kilometers. Accordingly, in order to implement a wide variety of all-optical devices, including optical switches and wavelength converters, using silica optical fiber the physical lengths of optical fiber that need to be employed are correspondingly of hundreds of meters, where high optical power can be applied, to tens of kilometers where typical optical powers in optical networks are employed. It would be beneficial to engineer optical fibers with higher non-linearities allowing the lengths of the optical fiber within such devices to be reduced and/or the operating power to the devices to be reduced.

Accordingly, within the prior art substantial research has been directed to identifying alternate approaches, including, but not limited to:
Narrow-Core Fibers with Silica Cladding—narrow core and high doping levels to reduce the effective mode area, A_{eff}, and thereby enhance the non-linearity γ, where γ=2πn₂/λA_{eff};
Tapered Fibers with Air Cladding—standard fibers are stretched such that the surrounding air acts as the cladding;
Micro-Structured Fibers—air holes introduced within the cladding through techniques such as photonic crystals, holey fibers, etc; and
Non-Silica Fibers—use a different material with large values of n₂.

It would be beneficial therefore to provide an approach allowing the combination of two or more of these approaches in order to maximize the waveguide nonlinearity parameter by manufacturing the non-linear optical fiber out of a material with a large material nonlinearity and to ensure that the guided mode is strongly confined thereby minimizing the effective area. Further, a wide range of glasses that do not include silica as a major constituent may have physico-chemical properties which are useful for their application in fiber optics include, but are not limited to fluoride glasses, aluminosilicates, phosphate glasses, borate glasses, chalcogenide glasses, heavy metal oxide (such as tellurite oxide and bismuth oxide). Additionally a range of silicates may also have physico-chemical properties useful in fiber optics such as lead silicates for example. In many instances these glasses may be incompatible with the conventional prior art approaches to manufacturing glass fiber performs and fiber pulling towers to provide optical fibers with the required composition and mechanical dimensions/tolerances required.

By the very nature of seeking to exploit higher intrinsic material non-linearities and manipulate the resulting optical fibers for increased optical confinement the goal is to minimize the amount of optical fiber employed. Accordingly, the cost-benefit for optical fiber manufacturers to achieve the required mechanical dimensions/tolerances and compositions is dramatically different when considering that the intention is to replace tens of hundreds to tens of thousands of meters of silica optical fiber with only a few centimeters to tens of centimeters of high non-linearity fiber (HNLF).

For example, chalcogenide glasses have been of particular interest for non-linear device fabrication within the prior art as they exhibit one of the largest material nonlinearities, up to three orders of magnitude greater than that of silica, have low two photon absorption, and a short response time <100 fs, see for example R. E. Slusher et al in “Large Raman Gain and Non-Linear Phase Shifts in High-Purity As₂Se₃ Chalcogenide Fibers” (J. Opt. Soc. Am., Vol. 21(6), pp 1146-1155). It would accordingly be beneficial to exploit such materials with large material nonlinearity in waveguide structures with minimized effective area such as micro-tapers without the drawbacks of the prior art wherein the resulting micro-tapers are mechanically fragile and currently only manufactured with a basic transition geometry resulting from the adoption of fused fiber directional coupler manufacturing techniques to pull these micro-tapers. Micro-tapers have also been shown to provide a group-velocity dispersion that is broadly variable, see for example D-I. Yeom et al in “Low-threshold Supercontinuum Generation in Highly Non-Linear Chalcogenide Nanowires” (Opt. Lett., Vol. 33(7), pp 660-662) and L. Tong et al in “Single-Mode Guiding Properties of Sub-Wavelength-Diameter Silica and Silicon Wire Waveguides” (Opt. Express, Vol. 12(6), pp 1025-1035).

Combining both a large material nonlinearity and a small effective area, a wire made of AsSe fiber transitioned down to −1 μm in diameter was reported with a waveguide nonlinearity parameter of γ=93 W⁻¹ m⁻¹, see D-I. Yoam et al in “Enhanced Kerr Non-Linearity in Sub-Wavelength Diameter As(2)Se(3) Chalcogenide Fiber Tapers” (Opt. Express, Vol. 15(16), pp 10324-10329). Although this micro-taper provides one of the highest waveguide nonlinearities ever reported, its practical use is questionable due to mechanical and optical limitations. Mechanically, the few centimeters long and ˜1 μm wire will be extremely fragile and even removal from the tapering apparatus difficult without breaking the micro-taper. The unprotected micro-taper is also subject to surface damage and contamination in similar manners to the effects seen previously with the developments of fused fiber directional couplers and fiber Bragg gratings. Accordingly, such micro-tapers require mechanical protection which, within the prior art from corresponding optical fiber devices as fused fiber couplers, in-line optical fiber polarizers, and Bragg gratings, is applied after the manufacturing of the optical device. It would be evident to one skilled in the art that handling glass wires with central regions of a few centimeters long and ˜1 μm in diameter represents a major challenge with high yield.

Further, the traveling optical wave is also sensitive to the medium surrounding the AsSe wire since a non-negligible fraction (approximately 9%) of the fundamental mode power propagates outside the optimally non-linear wire. This represents a further drawback of the unprotected micro-taper in view of goal of optical devices that are insensitive to the environment and may in many instances dictate that environmental protection is achieved by applying additional materials to the drawn micro-taper which as noted above is a few centimeters long and ˜1 μm diameter in diameter.

Amongst the plethora of potential glasses As₂Se₃ chalcogenide glass has been reported in the prior art to form optical fibers in combination with polymers and tellurite glass. For example, B. Temelkuran et al in “Wavelength-Scalable Hollow Optical Fibers with Large Photonic Band-Gaps for CO₂ Laser Transmission” (Nature, Vol. 420(6916), pp 650-653) and U.S. Pat. No. 7,272,285 entitled “Fiber Waveguides and Methods of Making the same” reports on Bragg fibers, which are photonic-bandgap fibers formed by concentric rings of multilayer film around a hollow or material core. Temelkuran teaches to wrapping a sheet of alternating layers of As₂Se₃ chalcogenide glass (AsSe) and poly-ether sulphone (PES) around a mandrel and subsequently drawing the resulting perform to form the Bragg fiber. Reported Bragg fibers by Temelkuran were geared to multi-mode operation at 10.6 μm with hollow core diameters of 700-750 μm and outer diameters of 1300-1400 μm employing a resulting AsSe/PES structure of a spiral of alternating layers 270 nm/900 nm with inner and outer AsSe layers of 135 nm. However, the work of Temelkuran was directed to forming optical waveguides and not optimizing non-linear effects within the resulting optical fiber (waveguide).

More recently, a photonic crystal fiber combining a chalcogenide core with a holey tellurite cladding has been fabricated to enable a demonstrated waveguide nonlinearity γ=9.3 W⁻¹ m⁻¹ and supercontinuum generation, see M. Liao et al “Fabrication and Characterization of a Chalcogenide-Tellurite Composite Microstructure Fiber with High Non-Linearity” (Opt. Express, Vol. 17(24), pp 21608-21614). Liao reports employing tellurite glass of composition 76.5TeO2-6Bi2O3-11.5Li2O-6ZnO (mol %) in conjunction with As₂Se₃. The manufacturing process being based upon preparing tellurite glass tubes by rotational casting and forming capillaries by elongating these tellurite tubes. An As₂Se₃ glass rod of diameter 1 mm, drawn by elongating a larger As₂Se₃ rod, was inserted into a capillary and sealed with the negative pressure of 90 kPa inside. The capillary containing the As₂Se₃ rod was then stacked centrally amongst an array of 14 other empty capillaries inside another tellurite glass tube.

The stacked tube was then elongated to a cane at 290° C. before being mounted into another jacket tube of tellurite glass and drawn into the optical fiber at 290° C. The resulting optical fiber had an outside diameter of 120 μm with diameters of the As₂Se₃ glass core, inner holes, and outer holes are 1.5 μm, 1.6-2.2 μm, 2.1-2.8 μm, respectively. The radius of the ring of outer holes (from the centre of the As2S3 core to the centre of the hole) is 4.6 μm, and for the inner ring is 3.1 μm. The resulting fiber demonstrated a flattened chromatic dispersion together with a zero dispersion wavelength located in the near infrared range and propagation losses at 1.55 μm were 18.3 dB/m. A super-continuum spectrum of 20-dB bandwidth covering 800-2400 nm was generated by this composite microstructure fiber. The optical mode profile of the single-mode fiber at 1.55 μm was calculated by Liao to be approximately 1 μm at full-width half-maximum providing a very small A_{eff}.

However, HNLF structures must also interface to the remainder of the optical system within which they are intended to operate, which when these are optical communication systems will typically be those based around single-mode silica fiber operating at 1300 nm and/or 1550 nm wherein the dominant fiber for several decades has been Corning SMF-28 offering maximum attenuation at 1.55 μm of 0.20 dB/km, dispersion below 18 ps·nm⁻¹·km⁻¹, and a mode field radius of 5.2±0.25 μm. Accordingly, it is necessary to transition from this mode field to that within the active region of the HNLF fiber with low loss and without requiring complex optical arrangements. It would therefore be beneficial for a manufacturing methodology for HNLF fiber to allow integration of transitions within the HNLF from one geometry of predetermined characteristics to another region of predetermined characteristics.

Further, providing a programmable transition geometry for the HNLF fiber would allow the manufacture of HNLF fibers that not only provide a large Kerr effect but also provide low insertion loss and defined dispersion characteristics. It would be further, beneficial for the HNLFs to be mechanically robust structures direct from the manufacturing equipment allowing normal handling without requiring additional processing steps which impact yield and hence cost of optical components employing HNLF fiber elements. Beneficially, such an approach would also limit the evanescent interaction with the environment, reduce surface contamination, and limit the formation of surface defects that ultimately propagate as micro-cracks within the HNLF fiber thereby degrading performance and potentially catastrophic failure.

Within the prior art for conventional optical fibers, such as Corning SMF-28 as well as erbium-ytterbium doped fibers for optical amplifiers, the most commonly used method for making fiber waveguides is drawing a circular fiber from a perform. A preform is a short rod, typically 250 mm to 500 mm having the precise form and composition of the desired fiber. The diameter of the preform, however, is much larger than the fiber diameter, typically hundreds to thousands of times larger. Typically, when drawing an optical fiber, the material composition of a preform includes a single glass having varying levels of one or more dopants provided in the preform core to increase the core's refractive index relative to the cladding refractive index. This ensures that the material forming the core and cladding are rheologically and chemically similar to be drawn, while still providing sufficient index contrast to support guided modes in the core.

To form the fiber from the preform a furnace heats the preform to a temperature at which the glass viscosity is sufficiently low (e.g., less than 108 Poise) to draw fiber from the preform. Upon drawing, the preform necks down to a fiber that has the same cross-sectional composition and structure as the preform. The diameter of the fiber is determined by the specific rheological properties of the fiber and the rate at which it is drawn but is typically 125 μm for optical telecommunications application such that drawn continuous fiber lengths of tens of kilometers are produced in a single drawing run.

Preforms can be made using many techniques known to those skilled in the art, including, but not limited to, modified chemical vapor deposition (MCVD), outside vapor deposition (OVD), plasma activated chemical vapor deposition (PCVD) and vapor axial deposition (VAD). Each process typically involves depositing layers of vaporized raw materials onto a wall of a pre-made tube or rod in the form of soot. Each soot layer is fused shortly after deposition. This results in a preform tube that is subsequently collapsed into a solid rod and drawn into fiber. Once drawn, the optical fiber is coated with a polymeric protective coating to a predetermined diameter, typically approximately 250 μm with good cladding-coating concentricity. For example, Corning SMF-28 is coated to 242±5 μm with a cladding-coating concentricity of <12 μm.

Within the prior art tapered optical fibers, as illustrated in FIG. 1 for example, have been manufactured in silica based optical fibers using a heat-and-draw approach developed originally in the late 1970s for the manufacture of fused star couplers, see for example B. Kawasaki et al in “Low Loss Access Coupler for Multimode Optical Fiber Distribution Networks” (Applied Optics, Vol. 16(7)), E. G. Rawson et al in “Bi-taper Star Couplers with up to 100 Fiber Channels” (Elect. Lett., Vol. 15(14)) and B. S. Kawasaki in U.S. Pat. No. 4,291,940. This approach was during the 1980s for single-mode optical fibers, see for example Y. Tremblay et al in U.S. Pat. No. 4,586,784 entitled “Modal-Insensitive Bi-Conical Taper Couplers”, M. Abebe et al in U.S. Pat. No. 4,612,028 entitled “Polarization-Preserving Single Mode Fiber Coupler”, and M. McLandrich in U.S. Pat. No. 4,763,272 entitled “Automated and Computer Controlled Precision Method of Fused Elongated Optical Fiber Coupler Fabrication.”

As shown in FIG. 1 an input section 170 of an optical fiber transitions through input transition region 110 to a wire region 120 before re-transitioning in output transition region 130 back to output section 180. In doing so the optical mode within the optical fiber transitions from fundamental mode 140 of the optical fiber through intermediate mode profiles 150 to the wire mode profile 160 and then back out to fundamental mode 140.

However, in such prior art techniques whilst the heating sequence and drawing process are computer controlled the tapered optical fibers are actively coupled into an optical system such that the optical properties of the directional, tree or star coupler define the end-point of the process when the split-ratio, loss, polarization extinction, etc are within the required specification for the particular component being manufactured. Whilst such an approach is easily implemented for passive optical splitters achieving the same when the tapered optical fiber is to form part of an all-optical wavelength switch or a dispersion compensator for an OC-192 (10 Gb/s) transmission system is not as simple and typically involves augmenting the tapered fiber manufacturing station, which in of itself is relatively low cost, with potentially tens of thousands to hundreds of thousands of dollars of automated optical and electrical test equipment.

Hence, whilst tapered optical fibers, such as illustrated in FIG. 1 made by a heat-and-draw approach have been used for enhancing nonlinear effects, coaxial mode coupling, filtering optical spectra, and switching in addition to power splitting/combining, these are generally research and development devices. It would therefore be beneficial to provide a means of automatically generating a tapered optical fiber, for example a HNLF, allowing stand-alone manufacturing of these elements of optical devices and sub-systems. It would be evident that such an approach should provide a fine control of the resulting transition shape in order to ensure that generally conflicting requirements for low loss through adiabatic transformation of the propagating mode, predetermined dispersion characteristics, non-linearity, etc are managed in the final tapered fiber design.

Within the prior art the tapering model presented by Birks et al in “The Shape of Fiber Tapers” (J. Lightwave Technol., Vol. 10, pp 432-438) has been employed to model the shaping of a fiber transition by changing the hot-zone length as the fiber is symmetrically stretched under tensile force at both ends. Birks' model can be implemented using a stationary heater with a variable-length hot-zone, or using a heat-brush approach originally presented by F. Bilodeau et al in “Low-Loss Highly Over-Coupled Fused Couplers: Fabrication and Sensitivity to External Pressure” (Optical Fiber Sensors, p. ThCC10, 1988) where a heater travels back and forth within a variable-length brushing-zone. The heat-brush implementation of Birks' model provides better precision in shaping fiber transitions than the stationary heater implementation; see for example R. P. Kenny et al in “Control of Optical Fibre Taper Shape” (Electron. Lett., Vol. 27, pp 1654-1656). The heater in the heat-brush implementation can be, for example, a flame, a resistive heater, or a CO₂ Laser.

The stationary heater implementation of Birks' model has been analyzed theoretically and numerically by S. Xue et al in “Theoretical, Numerical, and Experimental Analysis of Optical Fiber Tapering,” (J. Lightwave Technol., Vol. 25, pp. 1169-1176) using a viscous flow model, such as presented by J. Dewynne et al in “On a Mathematical Model for Fiber Tapering” (SIAM J. Appl. Math., Vol. 49, pp 983-990). There have also been a few heuristic theoretical and numerical analyses of transition shape evolution in the heat-brush implementation of Birks' model, see for example S. Pricking et al in “Tapering Fibers with Complex Shape” (Opt. Express 18, pp 3426-3437) and W. Sun et al in “Theoretical Shape Analysis of Tapered Fibers using a Movable Large-Zone Furnace” (Optoelectron. Lett., Vol. 7, pp 154-157).

In the heat-brush implementation of Birks' model, a point-like heat source heats only a small section of the fiber at any particular time, and travels with constant speed in an oscillatory manner along a distance, L, of the fiber so that in each cycle of oscillation every element the length L is heated equally. If the burner's speed is large compared to the speed of transition elongation then a time averaged hot-zone is established within the fiber that satisfies the assumptions of Birk's model. As the effective hot-zone length therefore is equal to the travel range of the burner this is a known controllable value and hence why the heat-brush method has found itself the dominant method in fabricating transitions and fused fiber devices within the prior art.

However, as a result a transitioning function s=ν_{f}/ν_{d}, where ν_{f} is the feed velocity and ν_{d} is the draw velocity, is constant throughout each transitioning sweep within the heat-brush approach. A constant s limits the lowest inverse transitioning ratio ρ=φⱼ/φⱼ₋₁=\sqrt{s}, where φ_{f} is the wire diameter after sweep j, that can be used in each sweep as reported by S. Leon-Saval et al in “Super-Continuum Generation in Sub-Micron Fibre Waveguides” (Opt. Express, Vol. 12, pp 2864-2869). If ρ is less than 0.97, see Kenny et al, the transition diameter in the transition region does not change smoothly, but rather it changes in steps.

Accordingly, the inventors have established a new model and approach to transitioning, which they refer to as a “generalized heat-brush method” or “multi-step transitioning” approach that allows s to change during each heater sweep along the brushing zone, and hence, the transition shape is carved within each sweep rather than having a sudden change in diameter. Just as in the heat-brush approach, the generalized heat-brush approach allows for precise shaping of the transition regions, a uniform wire profile, and a large contrast ratio between the initial and the final transition diameters. However, additionally the generalized approach allows for a smaller p in each sweep as well as controlled fabrication of transitions with an arbitrary wire profile and dissimilar transition regions.

An alternate approach to that of the inventors is reported by K. R. Harper et al in U.S. Patent Application 2009/0,320,527 entitled “Apparatus and Method for Tapering Optical Fibers to Conform to a Desired Radial Profile.” Harper teaches a method based upon control parameters of axial position of the softened portion, repositioning speed, elongation distance and elongation rate, which are definable with reference to an axial coordinate reference which is “normalized” such that the coordinate domains of the fiber initially, zᵢ, and finally, z_{f}, are identical. The normalized axial reference allows individual points on or within a segment as defined by the initial radial profile to be mapped to corresponding individual points on or within the segment in the form of desired radial profile. Through such a “normalized” axial coordinate reference, the segment according to both its initial radial profile and its final radial profile are relatable to one another. Harper's approach recognizes the dimensional symmetry which results from elongating a small softened portion of a fiber segment such that the normalized axial coordinate reference are defined such that zᵢ and z_{f} are both centered about the origin (zero) of the normalized axial coordinate reference system, i.e. zᵢ₁=−zᵢ₂ and z_{f1}=−z_{f2}, where 1,2 relate to the left and right hand sides of the initial and final segments.

The domains zᵢ and z_{f} over which their respective radii rᵢ and r_{f} are defined are both conformed to the domain, zₙ, of the normalized axial coordinate reference such that although the domain, zᵢ, of the initial radial profile and the domain, z_{f}, of the desired radial profile differ from one another when expressed in actual dimensions, each can be mapped to the normalized axial coordinate reference so that, in normalized terms, the domains of both profiles cover the interval from [−1,1]. The actual domain, zᵢ, of the initial radial profile can be related to a normalized domain zₙ, by the relationship in Equation (2) below.

$${z}_{n} = \frac{{z}_{i}}{{z}_{i 2}} \qquad ( 2 )$$

Harper further teaches that a user specifies at least one control parameter such as repositioning speed or elongation rate based on considerations such as thickness of the fiber, to be transitioned and any constraints imposed by such factors as the available heat output of the heat source, speed limitations of the manufacturing apparatus, etc. Once either repositioning speed or elongation rate is specified, the other one of those parameters is determinable based upon the equations presented by Harper. Accordingly, Harper teaches n view of the foregoing, it will be appreciated that the invention allows the elongation distance, elongation rate, axial position of the softened portion, and repositioning speed for each axial location all to be determined directly from the initial radial profile of the segment and the desired radial profile of the segment, both of which are known in advance.

Accordingly, whilst Harper teaches a method that provides for increased flexibility in design of the transitions the transitions are symmetric with respect to the centre of the final fabricated fiber taper. In contrast the generalized heat-brush method of the inventors allows the wire profile of the transition to follow an arbitrary function allowing additional freedom in both transition design and the range of transition applications. Beneficially using a smaller s in each sweep of the generalized heat-brush method according to embodiments of the invention reduces the number of sweeps required in the transitioning process, and hence, reduces the transition fabrication duration and cost. As will be evident from the descriptions below in respect to embodiments of the invention the generalized heat-brush approach also allows the design of asymmetric transitions with dissimilar transition regions at either end of the fabricated transition structure.

Non-uniform wire profiles in tapered fibers shift the zero-dispersion wavelength along the micro-taper wire for extended and flat super-continuum generation, see for example A. Kudlinski et al in “Zero Dispersion Wavelength Decreasing Photonic Crystal Fibers for Ultraviolet-Extended Super-continuum Generation” (Opt. Express, Vol. 14, pp 5715-5722) and G. Qin et al in “Zero-Dispersion-Wavelength-Decreasing Tellurite Micro-Structured Fiber for Wide and Flattened Super-Continuum Generation” (Opt. Lett., Vol. 35, pp 136-138 (2010). Such non-uniform transitions are also advantageous in enhanced soliton self-frequency shifting, see A. C. Judge et al in “Optimization of the Soliton Self-Frequency Shift in a Tapered Photonic Crystal Fiber” (J. Opt. Soc. Am. B, Vol. 26, pp 2064-2071) and A Alkadery et al in “Widely Tunable Soliton Shifting for Mid-Infrared Applications” (IEEE Photonics Conference 2011, 2011).

Dissimilar transition regions also provide additional freedom in transition design for other applications, such as soliton self-frequency shifting due to the Raman effect, for example. The spectrum of a soliton slides towards longer wavelengths as it propagates from the input end to the output end of a transition. Further designs that minimize the overall length of the fiber taper have dissimilar adiabatic transition regions, see for example J. D. Love et al in “Tapered Single-Mode Fibres and Devices: I—Adiabaticity Criteria” (IEE Proc.-J: Optoelectron., Vol. 138, pp 343-354.

Beneficially, the generalized heat approach according to embodiments of the invention by the inventors not only allows an arbitrary profile to be created for drawing an optical fiber into a fiber taper but it also allows a manufacturer to fabricate optical fiber tapers directly from a preform establishing a first section having a profile for coupling the final taper to standard telecommunication optical fibers, such as Corning SMF-28, a first transition section transitioning to the desired geometry according to the requirements of the device being fabricated, an optical central portion, a second transition section transitioning in a desired geometry back to a second section having a profile for coupling the final transition to standard telecommunication optical fibers.

Further, the technique further allows novel optical fiber geometries to be fabricated, which the inventors refer to a hybrid tapers wherein additional elements such as coatings, which provide mechanical and environment protection, may be incorporated into the initial preform and processed simultaneously with the fabrication of the optical taper such that the final fabricated hybrid tapers are mechanically robust, handlable, etc thereby improving manufacturing yield and reducing cost.

For example, the inventors have previously fabricated and reported hybrid AsSe-PMMA micro-tapers that offer ultrahigh waveguide nonlinearity for all-optical signal processing, enhanced mechanical robustness for normal handling of the taper, and reduced sensitivity to the surrounding environment. These micro-tapers were fabricated from single-mode chalcogenide fibers coated with a PMMA layer. A single-mode As₂Se₃ fiber was used to ensure single-mode propagation in the wire section of the micro-taper given that the transition shape satisfies the adiabaticity criteria and to provide easy coupling to standard single mode silica-fibers.

According to an embodiment of the invention with the generalized heat-brush technique a preform of As₂Se₃, diameter 170 μm for example, is coated with PMMA and drawn so that regions of fiber are formed, with diameter 15.5 μm, as well as micro-tapers with diameters below 0.5 μm. Beneficially transitioning the preform in this manner spreads higher order modes into the PMMA cladding wherein they either get absorbed by the PMMA cladding or are coupled to radiation modes due to slight “bends” in the optical fiber arising from the micro-taper wire. Consequently, the only transmitted mode within the hybrid fibers micro-taper is the fundamental mode despite the large index contrast between the As₂Se₃ core and PMMA cladding. The ability to generate complex transition profiles allows the design of tapers with slopes in the transition region that satisfy the adiabaticity criteria but also that there are no severe bends in the transition regions and un-transitioned sections of the hybrid fiber to avoid coupling between the fundamental mode and higher order modes.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to provide manufacturing methods for optical fibers and tapered optical fibers

In accordance with an embodiment of the invention there is provided a method comprising:

a) receiving at least a preform characteristic of a plurality of preform characteristics relating to a geometry of an optical preform;
b) receiving at least a fiber characteristic of a plurality of fiber characteristics relating to a geometry of an optical fiber;
c) generating a carving sequence comprising at least one carving profile of a plurality of carving profiles in dependence upon at least the preform characteristic and the fiber characteristic; and
d) executing the carving sequence by executing each carving profile of the plurality of carving profiles in order to fabricate the optical fiber from the optical preform.

In accordance with an embodiment of the invention there is provided a device comprising an optical fiber comprising a first section of a first length and a first diameter; wherein the device is manufactured using a process comprising executing a carving sequence by executing each carving profile of the plurality of carving profiles in order to fabricate the device from an optical preform.

In accordance with an embodiment of the invention there is provided a non-transitory tangible computer readable medium encoding a computer program for execution by the microprocessor, the computer program for executing a computer process comprising:

a) receiving at least a preform characteristic of a plurality of preform characteristics relating to a geometry of an optical preform;
b) receiving at least a fiber characteristic of a plurality of fiber characteristics relating to a geometry of an optical fiber;
c) generating a carving sequence comprising at least one carving profile of a plurality of carving profiles in dependence upon at least the preform characteristic and the fiber characteristic; and
d) executing the carving sequence by executing each carving profile of the plurality of carving profiles in order to fabricate the optical fiber from the optical preform.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic of an optical taper;

FIG. 2 depicts an arbitrary transition profile versus distance as well as the transitioning function required to achieve it;

FIG. 3 depicts a process flow which describes a program used to simulate a single-sweep tapering system;

FIG. 4 depicts single-sweep simulation schematics of shifting the hot-zone and extension of the fiber during a tapering sequence;

FIG. 5 depicts a simulation of step-taper fabrication using the single-sweep tapering method;

FIG. 6 depicts the overshoot and settling distance dependence against inverse tapering ratio at different hot-zone lengths when implementing the step-transition;

FIG. 7 depicts simulated fabrication results of taper profiles with linear transition regions at different slopes using the single-sweep tapering method;

FIG. 8 depicts a schematic of the experimental implementation of the tapering method according to an embodiment of the invention;

FIG. 9 depicts experimentally measured profiles of a step transition and an arbitrary transition fabricated using the single-sweep tapering method;

FIG. 10 depicts a schematic of transition profile evolution using a multi-sweep tapering method according to an embodiment of the invention;

FIG. 11 depicts a multi-sweep method of dividing a transition into sections for the determination of the transitioning function of each tapering stage according to an embodiment of the invention;

FIG. 12 depicts percent overshoot and maximum percent overshoot versus the number of tapering sweeps for a step-transition manufactured with a multi-step tapering system according to an embodiment of the invention;

FIG. 13 depicts experimental results for the profile of an As2Se3 transition fabricated using the multi-sweep tapering method with n=24 according to an embodiment of the invention;

FIG. 14 depicts coupling efficiency and reflectivity as a function of core diameter for an hybrid AsSe-PMMA fiber according to an embodiment of the invention;

FIG. 15 depicts effective index versus micro-taper diameter for HE11 and HE21 modes in an hybrid AsSe-PMMA fiber according to an embodiment of the invention;

FIG. 16A depicts the adiabaticity criteria for a tapered hybrid AsSe-PMMA fiber according to an embodiment of the invention;

FIG. 16B depicts waveguide nonlinearity parameter and chromatic dispersion of a hybrid AsSe-PMMA micro-taper at a wavelength of 1550 nm according to an embodiment of the invention;

FIG. 17 depicts the measured transmission through a hybrid AsSe-PMMA micro-taper according to an embodiment of the invention;

FIG. 18 depicts an optical micrograph of a hybrid AsSe-PMMA fiber manufactured according to an embodiment of the invention;

FIG. 19 depicts a waveguide nonlinearity parameter and chromatic dispersion of a hybrid AsSe-PMMA micro-taper at a wavelength of 1550 nm according to an embodiment of the invention;

FIG. 20 depicts an optical micrograph of the wire section of an optical micro-taper fabricated according to an embodiment of the invention;

FIG. 21 depicts measured optical spectrum of pulses for a hybrid AsSe-micro-taper with a 1.7 μm wire diameter at increasing peak power levels as manufactured according to an embodiment of the invention;

FIG. 22 depicts output pulse spectra of a hybrid AsSe-micro-taper with a 1.8 μm wire diameter for increasing peak power levels as manufactured according to an embodiment of the invention;

FIG. 23 depicts output pulse spectra of a hybrid AsSe-micro-taper with a 0.8 μm wire diameter for increasing peak power levels as manufactured according to an embodiment of the invention;

FIG. 24 depicts experimental and simulated output pulse spectra of the hybrid AsSe-micro-taper with a 0.8 μm wire diameter for increasing peak power levels as manufactured according to an embodiment of the invention;

FIG. 25 depicts an optical preform according to an embodiment of the invention comprising a polymer rod with two AsSe inserts;

FIG. 26 depicts a schematic of a telecommunications system and manufacturing with respect to manufacturing an optical device specific to the requirements of the telecommunications system according to an embodiment of the invention;

FIG. 27 depicts an exemplary process flow according to an embodiment of the invention for designing and carving an optical fiber with integrated optical taper/micro-taper from a preform;

FIG. 28 depicts an exemplary manufacturing sequence according to an embodiment of the invention for designing and carving an optical fiber with integrated optical taper/micro-taper from a preform; and

FIG. 29 depicts integrated optical fiber/micro-taper designs according to embodiments of the invention wherein preforms are either longitudinally uniform or non-uniform.

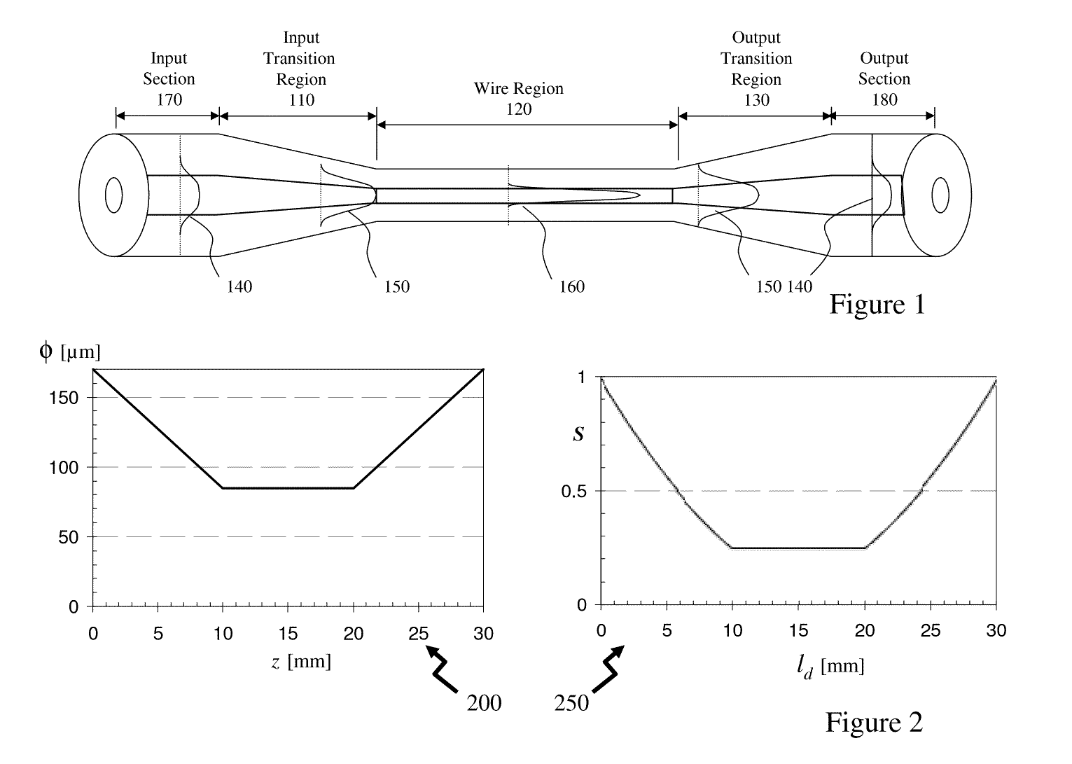

### DETAILED DESCRIPTION

The present invention is directed to optical fibers and more specifically to methods of manufacturing optical fibers and tapered optical fibers.

Within the following description reference may be made below to specific elements, numbered in accordance with the attached figures. The discussion below should be taken to be exemplary in nature, and not as limiting the scope of the present invention. The scope of the present invention is defined in the claims, and should not be considered as limited by the implementation details described below, which as one skilled in the art will appreciate, can be modified by replacing elements with equivalent functional elements or combination of elements. Within these embodiments reference will be made to terms which are intended to simplify the descriptions and relate them to the prior art, however, the embodiments of the invention should not be read as only being associated with prior art embodiments.

Optical Fiber Core-Cladding Materials:

In this specification the inventors describe a generalized heat-brush tapering method, and use it for the fabrication of transitions with a non-uniform wire profile and dissimilar transition regions. Within embodiments of the invention described below with respect to the Figures reference is made to As₂Se₃ chalcogenide glass fibers and As₂Se₃-PMMA fibers. However, it would be apparent to one skilled in the art that the techniques are applicable to a wide range of glasses and other materials to provide the core—cladding materials within an optical fiber/fiber taper/fiber micro-taper provided a few constraints in their selection are met as will be described below. Glasses that may be exploited include, but are not limited to oxides, fluorides, phosphates, and chalcogenides whilst other materials include, but are not limited to amorphous alloys and nano-particles whilst the materials may further included engineered micro-structures.

Oxides:

The most common oxide glass for optical communications is silica which exhibits good optical transmission over a wide range of wavelengths, particularly in the near-infrared (near IR) portion of the spectrum around 1.5 μm where extremely low absorption and scattering losses result in attenuation of the order of 0.2 dB/km. High transparency in the 1.4-1 μm region can be achieved through ensuring a low concentration of hydroxyl groups (OH). Alternatively, a high OH concentration is better for transmission in the ultraviolet (UV) region. Silica may be doped with various materials, such as for modifying refractive index, for example raising it with germanium dioxide (GeO2) or aluminum oxide (Al2O3) or lowering it with fluorine or boron trioxide (B2O3).

Doping is also possible with laser-active ions, for example rare earth-doped fibers, in order to obtain active fibers to be used, for example, in fiber amplifiers or laser applications. Both the fiber core and cladding are typically doped, so that the entire assembly (core and cladding) is effectively the same compound, e.g. an aluminosilicate, germanosilicate, phosphosilicate or borosilicate glass. Particularly for active fibers, pure silica is usually not a very suitable host glass, because it exhibits a low solubility for rare earth ions. This can lead to quenching effects due to clustering of dopant ions and accordingly aluminosilicates are much more effective in this respect.

Essentially there are three classes of components for oxide glasses: network formers, intermediates, and modifiers. The network formers (silicon, boron, germanium) form a highly cross-linked network of chemical bonds. The intermediates (titanium, aluminum, zirconium, beryllium, magnesium, zinc) can act as both network formers and modifiers, according to the glass composition. The modifiers (calcium, lead, lithium, sodium, potassium) alter the network structure; they are usually present as ions, compensated by nearby non-bridging oxygen atoms, bound by one covalent bond to the glass network and holding one negative charge to compensate for the positive ion nearby. Some elements can play multiple roles; e.g. lead can act both as a network former (Pb4+ replacing Si4+), or as a modifier.

The presence of non-bridging oxygen lowers the relative number of strong bonds in the material and disrupts the network, decreasing the viscosity of the melt and lowering the melting temperature. The alkaline metal ions are small and mobile; their presence in glass allows a degree of electrical conductivity, especially in molten state or at high temperature. Their mobility however decreases the chemical resistance of the glass, allowing leaching by water and facilitating corrosion. Alkaline earth ions, with their two positive charges and requirement for two non-bridging oxygen ions to compensate for their charge, are much less mobile themselves and also hinder diffusion of other ions, especially the alkalis.

Addition of lead(II) oxide lowers melting point, lowers viscosity of the melt, and increases refractive index. Lead oxide also facilitates solubility of other metal oxides and therefore is used in colored glasses which may form portions of an optical fiber cladding to improve identification of the fibre type and visibility. The viscosity decrease of lead glass melt is very significant (roughly 100 times in comparison with soda glasses) which allows easier removal of bubbles and working at lower temperatures, which can be beneficial in the formation of preforms and modifying glass characteristics to reduce differences in thermal processing temperatures.

Examples of heavy metal oxide glasses with high refractive indices include Bi2O3-, PbO—, Tl2O3-, Ta2O3-, TiO2-, and TeO2- containing glasses. Oxide glasses with low refractive indices may include glasses that contain one or more of the following compounds: 0-40 mole % of M2O where M is Li, Na, K, Rb, or Cs; 0-40 mole % of M′O where M′ is Mg, Ca, Sr, Ba, Zn, or Pb; 0-40 mole % of M₂O₃ where M″ is B, Al, Ga, In, Sn, or Bi; 0-60 mole % P2O5; and 0-40 mole % SiO2.

Fluorides:

Fluoride glasses are a class of non-oxide optical quality glasses composed of fluorides of various metals. Because of their low viscosity, it is very difficult to completely avoid crystallization while processing it through the glass transition (or drawing the fiber from the melt). Thus, although heavy metal fluoride glasses (HMFG) exhibit very low optical attenuation, they are typically difficult to manufacture, are fragile, and have poor resistance to moisture and other environmental attacks. Their best attribute is that they lack the absorption band associated with the hydroxyl (OH) group (3200-3600 cm-1), which is present in nearly all oxide-based glasses. However, they may be incorporated into preforms wherein other glasses are provided to give mechanical integrity, environmental resistance etc.

An example of a heavy metal fluoride glass is the ZBLAN glass group, composed of zirconium, barium, lanthanum, aluminum, and sodium fluorides which have applications as optical waveguides in both planar and fiber form, especially in the mid-infrared (2-5 μm) range.

Phosphates:

Phosphate glass constitutes a class of optical glasses composed of metaphosphates of various metals. Instead of the SiO₄ tetrahedra observed in silicate glasses, the building block for this glass former is phosphorus pentoxide (P₂O₅), which crystallizes in at least four different forms. The most familiar polymorph comprises molecules of P₄O₁₀. Phosphate glasses can be advantageous over silica glasses for optical fibers with a high concentration of doping rare earth ions. A mix of fluoride glass and phosphate glass is fluorophosphate glass.

Chalcogenides:

The chalcogens, elements in group 16 of the periodic table, particularly sulfur (S), selenium (Se) and tellurium (Te), react with more electropositive elements, such as silver, to form chalcogenides. These are extremely versatile compounds, in that they can be crystalline or amorphous, metallic or semiconducting, as well as conductors of ions or electrons. In addition to a chalcogen element, chalcogenide glasses may include one or more of the following elements: boron, aluminum, silicon, phosphorus, gallium, germanium, arsenic, indium, tin, antimony, thallium, lead, bismuth, cadmium, lanthanum and the halides (fluorine, chlorine, bromide, iodine).

Chalcogenide glasses can be binary or ternary glasses, e.g., As—S, As—Se, Ge—S, Ge—Se, As—Te, Sb—Se, As—S—Se, S—Se—Te, As—Se—Te, As—S—Te, Ge—S—Te, Ge—Se—Te, Ge—S—Se, As—Ge—Se, As—Ge—Te, As—Se—Pb, As—S—Ti, As—Se—Tl, As—Te—Tl, As—Se—Ga, Ga—La—S, Ge—Sb—Se or complex, multi-component glasses based on these elements such as As—Ga—Ge—S, Pb—Ga—Ge—S, etc. The ratio of each element in a chalcogenide glass can be varied. For example, a chalcogenide glass with a suitably high refractive index may be formed with 5-30 mole % Arsenic, 20-40 mole % Germanium, and 30-60 mole % Selenium.

Amorphous Alloys:

In some instances amorphous alloys with high refractive indices may be employed, examples of which include Al—Te and R—Te(Se) (R=alkali).

Metals:

In some instances ductile metals may be employed, for example to form absorbers for polarizers or as elements within photonic crystal fibers, examples of which include gold, silver, platinum, and copper.

Micro-Structures:

Portions of optical fiber can optionally include mechanical structures such that they act as a photonic-crystal fiber (PCF) upon formation of the optical fiber/fiber taper/micro-taper. Such PCF's may include, but not be limited to, photonic-bandgap fibers that confine light by band gap effects, holey fibers which use air holes in their cross-sections, and hole-assisted fiber wherein waveguiding is achieved through a conventional higher-index core modified by the presence of air holes. Accordingly such PCF properties may be varied during the controlled profiling of the fiber taper and/or micro-taper according to embodiments of the invention.

Nano-Particles:

Portions of high index-contrast fiber waveguides can be homogeneous or inhomogeneous. For example, one or more portions can include nano-particles (e.g., particles sufficiently small to minimally scatter light at guided wavelengths) of one material embedded in a host material to form an inhomogeneous portion. An example of this is a high-index polymer composite formed by embedding a high-index chalcogenide glass nano-particles in a polymer host. Further examples include CdSe and or PbSe nano-particles in an inorganic glass matrix.

Cladding—Coating Materials:

As noted above and as described below with respect to the Figures in respect of embodiments of the invention optical fibers/fiber tapers/micro-tapers may be fabricated directly with coatings for environmental/mechanical performance as well as forming part of the overall refractive index profile of the optical fibers/fiber tapers/micro-tapers. As such the coating may form part of the initial preform from which the optical fibers/fiber tapers/micro-tapers are formed. Specific reference is made to PMMA as a coating for As₂Se₃ chalcogenide glass fibers in respect of embodiments of the invention below. However, it would be apparent to one skilled in the art that the techniques are applicable to a wide range of other polymers, glasses and other materials to provide cladding and coatings for these optical fiber/fiber taper/fiber micro-taper structures provided a few constraints in their selection are met as will be described below.

Glasses:

Glasses with lower index of refraction than the optical fiber materials to form a coating may include oxides, fluorides, phosphates, and chalcogenides as described above.

Polymers:

Polymers with lower index of refraction than the core optical fiber material may form part of the overall optical fiber design in addition to forming part of the mechanical and/or environmental protection of the final optical fiber/fiber taper/micro-taper/microwire. Further multiple polymers may be used in conjunction with each other to provide different aspects of these overall design goals as well as specific characteristics to the final fabricated devices. Amongst such polymeric materials, thermoplastic materials may be used according to embodiments of the invention which are not specifically defined and may include, for example, polyolefin-based resins, polystyrene-based resins, polyvinyl chloride-based resins, polyamide-based resins, polyester-based resins, polyacetal-based resins, polycarbonate-based resins, polyaromatic ether or thioether-based resins, polyaromatic ester-based resins, polysulfone-based resins, acrylate-based resins, etc.

The polyolefin-based resins include, for example, homopolymers and copolymers of α-olefins, such as ethylene, propylene, butene-1,3-methylbutene-1,3-methylpentene-1,4-methylpentene-1; and copolymers of such α-olefins with other copolymerizable, unsaturated monomers. As specific examples of the resins, mentioned are polyethylene-based resins such as high-density, middle-density or low-density polyethylene, linear polyethylene, ultra-high molecular polyethylene, ethylene-vinyl acetate copolymer, ethylene-ethyl acrylate copolymer; polypropylene-based resins such as syndiotactic polypropylene, isotactic polypropylene, propylene-ethylene block or random copolymer; poly-4-methylpentene-1, etc.

The styrene-based resins include, for example, homopolymers and copolymers of styrene and α-methylstyrene; and copolymers thereof with other copolymerizable, unsaturated monomers. As specific examples of the resins, mentioned are general polystyrene, impact-resistant polystyrene, heat-resistant polystyrene (α-methylstyrene polymer), syndiotactic polystyrene, acrylonitrile-butadiene-styrene copolymer (ABS), acrylonitrile-styrene copolymer (AS), acrylonitrile-polyethylene chloride-styrene copolymer (ACS), acrylonitrile-ethylene-propylene rubber-styrene copolymer (AES), acrylic rubber-acrylonitrile-styrene copolymer (AAS), etc.

The polyvinyl chloride-based resins include, for example, vinyl chloride homopolymers and copolymers of vinyl chloride with other co-polymerizable, unsaturated monomers. As specific examples of the resins, mentioned are vinyl chloride-acrylate copolymer, vinyl chloride-methacrylate copolymer, vinyl chloride-ethylene copolymer, vinyl chloride-propylene copolymer, vinyl chloride-vinyl acetate copolymer, vinyl chloride-vinylidene chloride copolymer, etc. These polyvinyl chloride-based resins may be post-chlorinated to increase their chlorine content, and the thus post-chlorinated resins are also usable in the invention.

The polyamide-based resins include, for example, polymers as prepared by ring-cleaving polymerization of cyclic aliphatic lactams, such as 6-nylon, 12-nylon; polycondensates of aliphatic diamines and aliphatic dicarboxylic acids, such as 6,6-nylon, 6,10-nylon, 6,12-nylon; polycondensates of m-xylenediamine and adipic acid; polycondensates of aromatic diamines and aliphatic dicarboxylic acids; polycondensates of p-phenylenediamine and terephthalic acid; polycondensates of m-phenylenediamine and isophthalic acid; polycondensates of aromatic diamines and aromatic dicarboxylic acids; polycondensates of amino acids, such as 11-nylon, etc.

The polyester-based resins include, for example, polycondensates of aromatic dicarboxylic acids and alkylene glycols. As specific examples of the resins, mentioned are polyethylene terephthalate, polybutylene terephthalate, etc.

The polyacetal-based resins include, for example, homopolymers, such as polyoxymethylene; and formaldehyde-ethylene oxide copolymers and ethylene oxide.

The polycarbonate-based resins include, for example, 4,4′-dihydroxy-diarylalkane-based polycarbonates. Preferred are bisphenol A-based polycarbonates to be prepared by phosgenation of reacting bisphenol A with phosgene, or by interesterification of reacting bisphenol A with dicarbonates such asdiphenylcarbonate. Also usable are modified bisphenol A-based polycarbonates, of which the bisphenol A is partly substituted with 2,2-bis(4-hydroxy-3,5-dimethylphenyl)propane or 2,2-bis(4-hydroxy-3,5-dibromophenyl)propane; and flame-retardant, bisphenol A-based polycarbonates.

The polyaromatic ether or thioether-based resins have ether or thioether bonds in the molecular chain, and their examples include polyphenylene ether, styrene-grafted polyphenylene ether, polyether-ether-ketone, polyphenylene sulfide, etc.

The polyaromatic ester-based resins include, for example, polyoxybenzoyl to be obtained by polycondensation of p-hydroxybenzoic acid; polyarylates to be obtained by polycondensation of bisphenol A with aromatic dicarboxylic acids such as terephthalic acid and isophthalic acid, etc.

The polysulfone-based resins have sulfone groups in the molecular chain, and their examples include polysulfone to be obtained by polycondensation of bisphenol A with 4,4′-dichlorodiphenylsulfone; polyether-sulfones having phenylene groups as bonded at their p-positions via ether group and sulfone group, polyarylene-sulfones having diphenylene groups and diphenylene-ether groups as alternately bonded via sulfone group, etc.

The acrylate-based resins include, for example, methacrylate polymers and acrylate polymers. As the monomers for those polymers, for example, used are methyl, ethyl, n-propyl, isopropyl and butyl methacrylates and acrylates. In industrial use, typically used are methyl methacrylate resins.

The thermoplastic resin(s) may be used either singly or in combination. Equally the thermoplastic resin(s) may be used alone or in combination with one or more thermosetting materials. Of the thermoplastic resins mentioned above, in many applications the selected materials are polypropylene-based resins such as polypropylene, random or block copolymers of propylene with other olefins, and their mixtures, as well as acid-modified polyolefin-based resins as modified with unsaturated carboxylic acid or their derivatives.

The polyolefin-based resins for the acid-modified polyolefin-based resins include, for example, polypropylene, polyethylene, ethylene-a-olefin copolymers, propylene-ethylene random-copolymers, propylene-ethylene block-copolymers, ethylene-a-olefin copolymer rubbers, ethylene-α-olefin-non-conjugated diene copolymers (e.g., EPDM), and ethylene-aromatic monovinyt compound-conjugated diene copolymer rubber:3. The α-olefins include, for example, propylene, butene-1, pentene-1, hexene-1, and 4-methylpentene-1, and one or more of these are usable either singly or as combined. Of those polyolefin-based resins, preferred are polypropylene-based or polyethylene-based resins containing copolymers, and more preferred are polypropylene-based resins.

Metals:

In some instances ductile metals may be employed, for example to form electrical contacts or wettable areas for soldering the micro-taper to a structure, examples of which include gold, silver, platinum, and copper.

Additional Materials in Core-Cladding-Coating:

It would be evident to one skilled in the art that the combination of materials described above as potential candidates for fabricating optical fibers/fiber tapers/micro-tapers according to embodiments of the invention by providing the core, cladding, and coating materials may include materials that alter the mechanical, rheological and/or thermodynamic behavior of those portions of the fiber to which they are added. For example, one or more of the portions can include a plasticizer. Portions may include materials that suppress crystallization, or other undesirable phase behavior within the optical fiber. For example, crystallization in polymers may be suppressed by including a cross-linking agent (e.g., a photosensitive cross-linking agent). In other examples, a nucleating agent, such as TiO2 or ZrO2, can be included in the material.

Further, portions of the overall structure can also include compounds designed to affect the interface between adjacent portions in the optical fiber, for example between the core and cladding, or cladding and coating. Such compounds include adhesion promoters and compatibilizers. For example, organo-silane compounds promote adhesion between silica-based glasses and polymers, whilst phosphorus or P₂O₅ is compatible with both chalcogenide and oxide glasses, and may promote adhesion between portions formed from these glasses.

Optionally, the optical fiber can include additional materials specific to particular fiber waveguide applications such as for example a dopant or combination of dopants capable of interacting with an optical signal in the fiber to enhance absorption or emission of one or more wavelengths of light by the fiber. Alternatively, they can include nonlinear materials with high nonlinearity, such as for example materials with high Kerr nonlinear index (n₂).

Material Compatibility Considerations:

When fabricating optical fibers/fiber tapers/micro-tapers using the procedures according to embodiments of the invention it would be apparent that not every combination of materials, including but not limited to those outlined above, with desirable optical properties are necessarily suitable or compatible. Typically, one would select materials that are rheologically, thermo-mechanically, and physico-chemically compatible. However, it would also be apparent that these compatibility issues may change when considering highly nonlinear micro-tapers of a few centimeters or tens of centimeters to hundred of meters to tens of kilometers of fiber. Several criteria for selecting compatible materials will now be discussed.

Rheological:

A first criterion is to select materials that are rheologically compatible in that one selects materials that have viscosities within predetermined bounds over a broad temperature range, corresponding to the temperatures experience during the different stages of fiber preform fabrication, optical fiber drawing, tapering, and actual system operation. As noted above these predetermined bounds for viscosity may vary with the materials themselves as well as the dimensions of the final fabricated optical device. Viscosity is the resistance of a fluid to flow under an applied shear stress and measured in Poise. Typically materials are characterized by temperatures such as annealing point, softening point, working point, and melting point that are actually defined in terms of the given material has a specific viscosity. Accordingly a material may have viscosities of 1013, 107.65, 104, and 102 Poise respectively at the annealing point, softening point, working point, and melting point. In addition to considering the rheological compatibility at these temperatures consideration should also be given to the change in viscosity as a function of temperature, i.e., the viscosity slope, so that stress etc are not introduced as the materials transitions from one temperature range, e.g. the heat-brush process, to another, e.g. room temperature.

Temperature Expansion Coefficient:

A second selection criterion for materials is that the thermal expansion coefficients (TEC) of each material should be within predetermined limits at temperatures between the annealing temperatures and room temperature. In other words, as the fiber cools and its rheology changes from liquid-like to solid-like, both materials' volume should change by similar amounts. If the two materials TEC's are not sufficiently matched, a large differential volume change between two fiber portions can result in a large amount of residual stress buildup, which can cause one or more portions to crack and/or delaminate. Residual stress may also cause delayed fracture even at stresses well below the material's fracture stress.

For many materials, there are two linear regions in the temperature-length curve that have different slopes. There is a transition region where the curve changes from the first to the second linear region which is associated with a glass transition, where the behavior of a glass sample transitions from that normally associated with a solid material to that normally associated with a viscous fluid. The glass transition temperature is often taken as the approximate annealing point, where the viscosity is 1013 Poise, but in fact, typically measured glass transition temperatures are relative values and dependent upon the measurement technique employed.

Accordingly, the TEC can be an important consideration for obtaining fiber that is free from excessive residual stress, which can develop in the fiber during the draw process. Typically, when the TEC's of the two materials are not sufficiently matched; residual stress arises as elastic stress. The elastic stress component stems from the difference in volume contraction between different materials in the fiber as it cools from the glass transition temperature to room temperature (e.g., 25° C.). For embodiments in which the materials in the fiber become fused or bonded at any interface during the draw process, a difference in their respective TEC's will result in stress at the interface. One material will be in tension (positive stress) and the other in compression (negative stress), so that the total stress is zero. Moderate compressive stresses themselves are not usually a major concern for glass fibers, but tensile stresses are undesirable and may lead to failure over time.

It would also be apparent that whilst selecting materials having TEC's within predetermined limits can minimize an elastic stress component, residual stress can also develop from viscoelastic stress components. For example, consider a composite preform made of a glass and a polymer having different glass transition ranges (and different Tg's). During the processing the glass and polymer initially behave as viscous fluids and stresses due to the drawing process are relaxed instantly. However, subsequently the fiber rapidly loses heat, causing the viscosities of the fiber materials to increase exponentially, along with the stress relaxation time. Upon cooling to its Tg, the glass and polymer cannot practically release any more stress since the stress relaxation time has become very large compared with the draw rate. So, assuming the component materials possess different Tg values, the first material to cool to its Tg can no longer reduce stress, while the second material is still above its Tg and can release stress developed between the materials. Once the second material cools to its Tg, stresses that arise between the materials can no longer be effectively relaxed. Moreover, at this point the volume contraction of the second glass is much greater than the volume contraction of the first material (which is now below its Tg and behaving as a brittle solid). Such a situation can result sufficient stress buildup between the glass and polymer so that one or both of the portions mechanically fail. However, as there are two mechanisms, elastic and viscoelastic, then these mechanisms may be employed to offset one another. For example, materials constituting a fiber may naturally offset the stress caused by thermal expansion mismatch if mismatch in the materials Tg's results in stress of the opposite sign. Conversely, a greater difference in Tg between materials is acceptable if the materials' thermal expansion will reduce the overall permanent stress.

Thermal Stability:

A further selection criterion may be the thermal stability of candidate materials. A measure of the thermal stability is given by the temperature interval between the glass transition temperature and the temperature for onset of crystallization as a material cools slowly enough that each molecule can find its lowest energy state. Accordingly, a crystalline phase is a more energetically favorable state for a material than a glassy phase. However, a material's glassy phase typically has performance and/or manufacturing advantages over the crystalline phase when it comes to fiber waveguide applications. The closer the crystallization temperature is to the glass transition temperature, the more likely the material is to crystallize during drawing, which can be detrimental to the fiber, e.g., by introducing optical inhomogeneities into the fiber, which can increase transmission losses.

Single Sweep Tapering:

Before describing the generalized heat-brush technique we initially present the single-sweep tapering method, an instance of the well-known fiber-drawing approach, see for example Dewynne, F. Geyling in “Basic Fluid Dynamic Consideration in the Drawing of Optical Fibers” (Bell Sys. Tech. J., Vol. 55, pp 1011-1056), and N. Vukovic et al in “Novel Method for the Fabrication of Long Tapers” (Photon. Technol. Lett., Vol. 20, pp 1264-1266). In the process of fiber drawing, mass conservation leads to φ(t)=φ₀\sqrt{s(t)} where φ(t) is the transition diameter, φ₀ is the initial fiber diameter, and s(t)=ν_{f}(t)/ν_{d}(t) is the transitioning function. To draw a transition with a predefined profile φ(z), the transitioning function s(t) must be determined accordingly. The replacement of the time variable t by the drawing length l_{d}(t)=∫₀^{t}ν_{d}(τ)dτ simplifies the implementation of the single-sweep tapering method because it can be readily used as a feedback parameter to control the draw velocity ν_{d}(l_{d})=ν_{f}(l_{d})/s(l_{d}). In this case, the transitioning function s(l_{d}) is calculated from the transition profile φ(z) using Equation (3).

$$s ( {l}_{d} ) = \frac{{φ}^{2} ( z )}{{φ}_{0}^{2}} {\vert}_{z = {l}_{d}} \qquad ( 3 )$$

Referring to FIG. 2 there is depicted an arbitrary transition profile φ(z) versus distance in first graph 200 wherein the optical fiber tapers from φ(0)=170 μm linearly to φ(10)=85 μm, remains constant until φ(20)=85 μm and then linearly transitions back to φ(30)=170 μm. Accordingly, the resulting transitioning function s(l_{d}) required to achieve this arbitrary transition profile φ(z) is shown in second graph 250. Accordingly, this transitions from s(l_{d}=0)=1 in non-linear fashion until s(l_{d}=10)=0.25, is constant until s(l_{d}=20)=0.25, and then follows non-linearly until s(l_{d}=30)=1.

Single Sweep Tapering Modeling:

A general model of the viscous flow in the heat-softened region, or hot-zone, due to unidirectional stretching was reported by Geyling. A simplified model was derived by Dewynne for the case when the fiber diameter is much smaller than the hot-zone length (L_{Hz}). In this model, the deformation of the hot-zone due to stretching is governed by Equations (4A) and (4B).

$$\begin{matrix}\frac{\partial }{\partial z} ( 3 μ A \frac{\partial u}{\partial z} ) = 0. & ( 4 A ) \\ \frac{\partial A}{\partial t} + \frac{\partial }{\partial z} ( μ A ) = 0 & ( 4 B )\end{matrix}$$

where μ(z,t) is the viscosity distribution, u(z,t) is the axial velocity distribution, and A(z,t) is the cross-sectional area in the hot-zone [17]. For a Newtonian fluid, μ is independent of u, and hence leads to Equation (5).

$$\frac{\partial \overline{u}}{\partial z} \times \frac{\partial f}{\partial z} + F \times \frac{{\partial }^{2} \overline{u}}{\partial {z}^{2}} = 0 \qquad ( 5 )$$

where ū=u/ν_{d} is the normalized axial velocity and F=μA. Using the centered differentiation formulas of S. Chapra et al in “Numerical Methods for Engineers” (McGraw Hill) in Equations (6A) through (6C)

$$\begin{matrix}\frac{\partial F}{\partial z} = \frac{{F}_{i + 1} - {F}_{i - 1}}{2 Δ z} & ( 6 A ) \\ \frac{\partial \overline{u}}{\partial z} = \frac{{\overline{u}}_{i + 1} - {\overline{u}}_{i - 1}}{2 Δ z} & ( 6 B ) \\ \frac{{\partial }^{2} \overline{u}}{\partial {z}^{2}} = \frac{{\overline{u}}_{i + 1} - 2 {\overline{u}}_{i} + {\overline{u}}_{i - 1}}{Δ {z}^{2}} & ( 6 C )\end{matrix}$$

leads to the finite difference form of Equation (4A).

[Fᵢ−0.25(Fᵢ₊₁−Fᵢ₋₁)]ūᵢ₋₁−2Fᵢūᵢ+[Fᵢ+0.25(Fᵢ₊₁−Fᵢ₋₁)]ūᵢ₊₁=0 (7)

where Fᵢ=F(l_{d},zᵢ), ūᵢ=ū(l_{d},zᵢ), and Δz is the separation between any two consecutive zᵢ.

Changing the variable t to l_{d} in Equation (4B) leads to the Equation (8)

$${υ}_{d} \frac{\partial A}{\partial {l}_{d}} + \frac{\partial ( uA )}{\partial z} = 0 \qquad ( 8 )$$

which is expanded and divided by ν_{d} to obtain

$$\frac{\partial A}{\partial {l}_{d}} + A \frac{\partial u}{\partial z} + \overline{u} \frac{\partial A}{\partial z} = 0 \qquad ( 9 )$$

Using the centered differentiation formulas of Chapra in Equations (10A) through (10C)

$$\begin{matrix}\frac{\partial \overline{u}}{\partial z} = \frac{( {\overline{u}}_{i + 1} + {\overline{u}}_{i - 1} )}{2 Δ z} & ( 10 A ) \\ \frac{\partial A}{\partial z} = \frac{( {A}_{i + 1} - {A}_{i - 1} )}{2 Δ z} & ( 10 B )\end{matrix}$$

and the forward differentiation formula of Chapra

$$\frac{\partial A}{\partial {l}_{d}} = \frac{[ {A}_{i}^{new} - {A}_{i} ]}{Δ {l}_{d}} \qquad ( 10 C )$$

the finite difference form of Equation (4B) corresponding to the extension of the fiber by a distance Δl_{d}=2Δz is given by Equation (11)

Aᵢ^{new}=Aᵢ−[Aᵢ(ūᵢ₊₁−ūᵢ₋₁)+ūᵢ(Aᵢ₊₁−Aᵢ₋₁)] (11)

where Aᵢ=A(l_{d},zᵢ), and Aᵢ^{new}=A(l_{d}+Δl_{d},zᵢ). It is clear from Equations (7) and (11) that, for a Newtonian fluid, the deformation of the hot-zone is independent of the actual drawing velocity.

Carving Sequence:

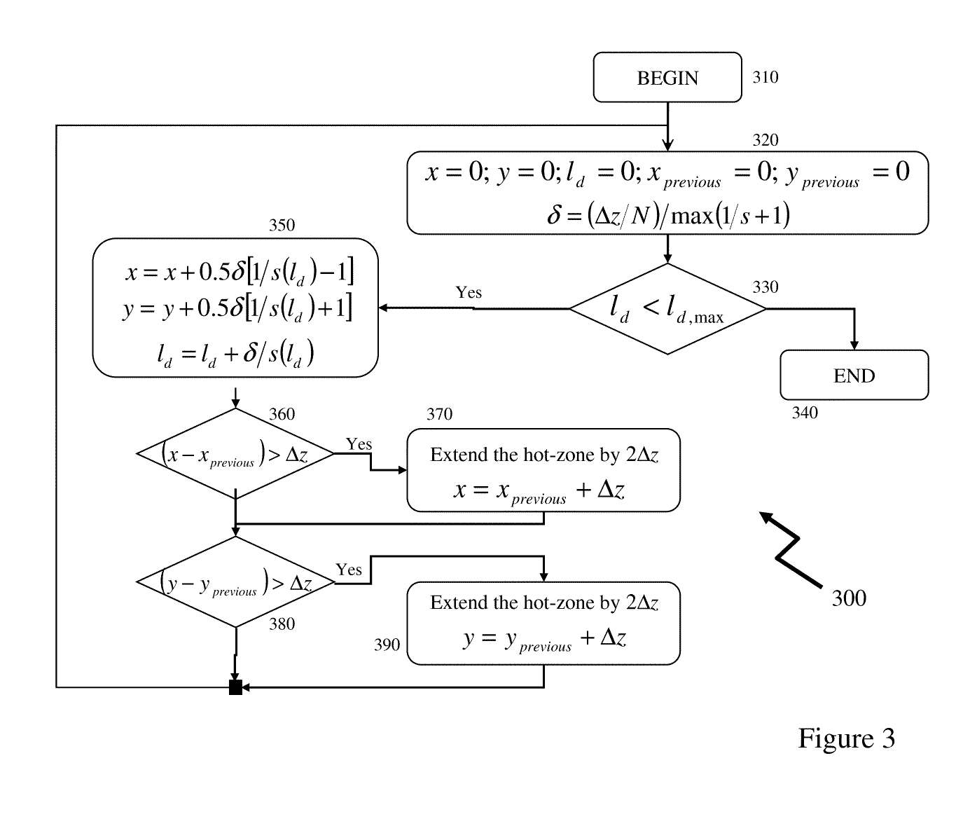

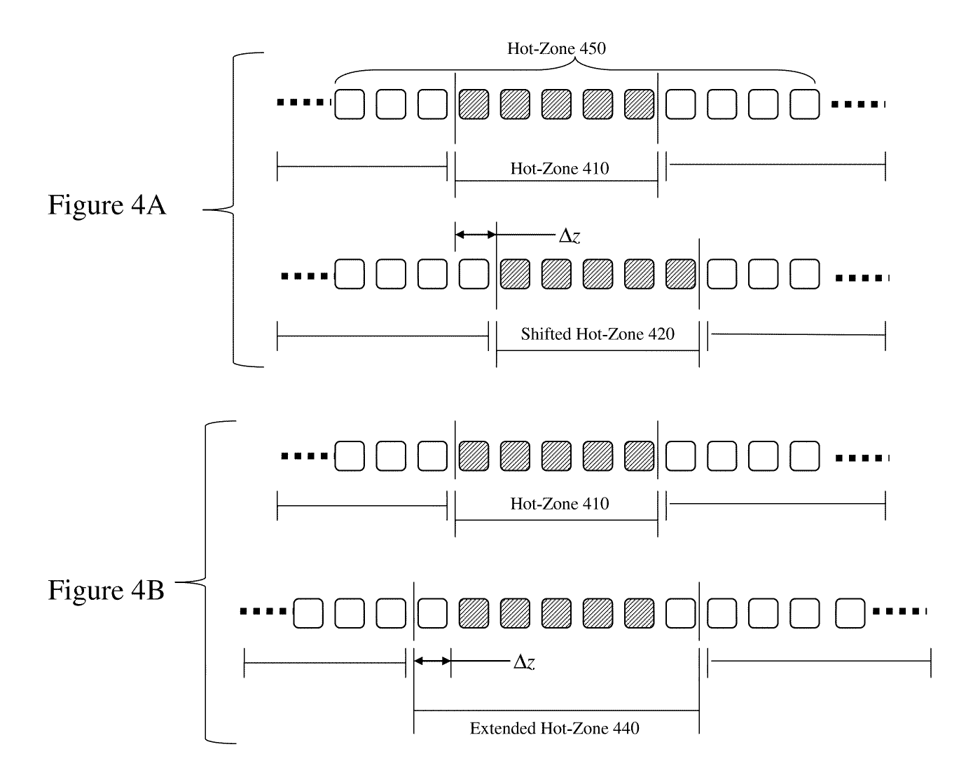

Referring to FIG. 3 there is depicted a process flow 300 which describes a program used to simulate the single-sweep experimental setup presented in Single Sweep Experimental Setup below. In this program, the transition profile is represented by an array of diameter values φₖ taken at points zₖ with any two consecutive points separated by Δz. The hot-zone is a sub-array of the transition array and the starting point of the hot-zone sub-array can change to simulate a moving heater as illustrated in FIG. 4A. The cross-section area in the hot-zone is given by Aᵢ where i=1, 2 . . . , N and the cross-section area of the extended hot-zone that results from drawing the hot-zone, as illustrated in FIG. 4B, is calculated as follows: first, Equation (7) is used with the boundary conditions ūᵢ₌₀=−½ and ū_{i=N+1}=½ to calculate the normalized axial velocity distribution ūᵢ in the hot-zone, and then, Equation (11) is used to calculate the extended hot-zone profile. In the simulations that follow, the hot-zone is assumed to have a uniform viscosity distribution.

Accordingly, process flow 300 begins at step 310 and progresses to step 320 wherein the parameters are initialized, including x representing the displacement of both translation stages extending the fiber, y representing the displacement of the heater translation stage, xₚᵣₑᵥᵢₒᵤₛ and yₚᵣₑᵥᵢₒᵤₛ which are state variables. Also δ the differential feed step is calculated in dependence upon s, being the transitioning function, Δz which represents the longitudinal separation between any two consecutive diameter sampling points, and a constant N which in this instance is set to N=10. Next in step 330 the process flow checks to see if the current drawing length, l_{d}, exceeds the maximum drawing length l_{d,max}. If it does then the process moves to step 340 and ends. If not, then the process moves to step 350 wherein the translation stage and heater translation stage displacements respectively are calculated using x=x+0.5δ[1/s(l_{d})−1] and y=y+0.5δ[1/s(l_{d})+1] together with the new drawn length is calculated l_{d}=l_{d}+δ/s(l_{d}).

Next in step 360 the process flow 300 determines if the current translation displacement exceeds the longitudinal separation between any two consecutive diameter sampling points, (x−xₚᵣₑᵥᵢₒᵤₛ)>Δz, which if it does the process flow 300 moves to step 370 wherein the hot-zone is extended by 2Δz such that x=xₚᵣₑᵥᵢₒᵤₛ+Δz and the process flow 300 moves to step 380 as it would also have done if the test in step 360 had been failed. In step 380 the process flow 300 determines if the current heater translation displacement exceeds the longitudinal separation between any two consecutive diameter sampling points, (y−yₚᵣₑᵥᵢₒᵤₛ)>Δz, which if it does the process flow 300 moves to step 390 wherein the hot-zone is extended by 2Δz such that y=yₚᵣₑᵥᵢₒᵤₛ+Δz and the process flow 300 moves back to step 320 as it would also have done if the test in step 380 had been failed.

As such referring to FIGS. 4A and 4B we see that in FIG. 4A the “Hot-Zone” 410 is an initial sub-array of the transition array 450 and the starting point of the hot-zone sub-array can change to simulate a moving heater as illustrated in FIG. 4A by “Shifted Hot-Zone” 420. Similarly, the result of extending is illustrated in FIG. 4B wherein “Hot=Zone 410” becomes “Extended Hot-Zone” 440 as the result of the drawing out process applied by the translation stages attached to the optical fiber.

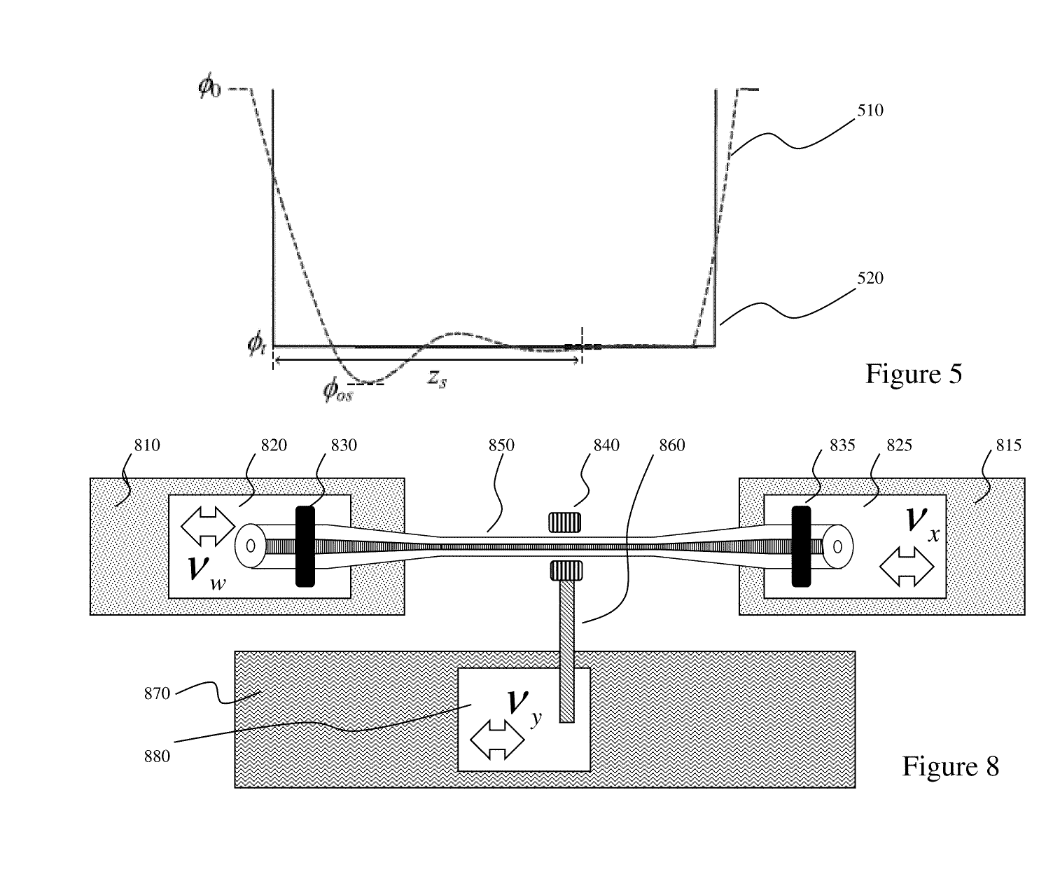

Referring to FIG. 5 the inventors simulated the fabrication of a step-transition 520 where the diameter changes abruptly from the initial fiber diameter to the final transition diameter. Accordingly, typical simulation results of step-transition fabrication show a transient response 510 in the resulting transition with an overshoot and oscillations in the wire before the diameter settles to a final value, as shown in FIG. 5. The mismatch between the resulting and the targeted transition profiles is quantified by the percent error along the transition defined as

$$ɛ ( z ) = \frac{[ {φ}_{r} ( z ) - {φ}_{t} ( z ) ]}{{φ}_{t} ( z )} \times 100 \% \qquad ( 12 )$$

where φᵣ is the resulting transition diameter and φₜ is the targeted transition diameter. The transient response is quantified by the percent overshoot

$${ɛ}_{OS} = \frac{[ {φ}_{t} - {φ}_{OS} ]}{{φ}_{t}} \times 100 \%$$

where φ_{OS} is the overshoot diameter, and by the settling distance zₛ defined as the distance between the beginning of the wire and the point where the envelope of the absolute percent error is less than εₛ=2%.

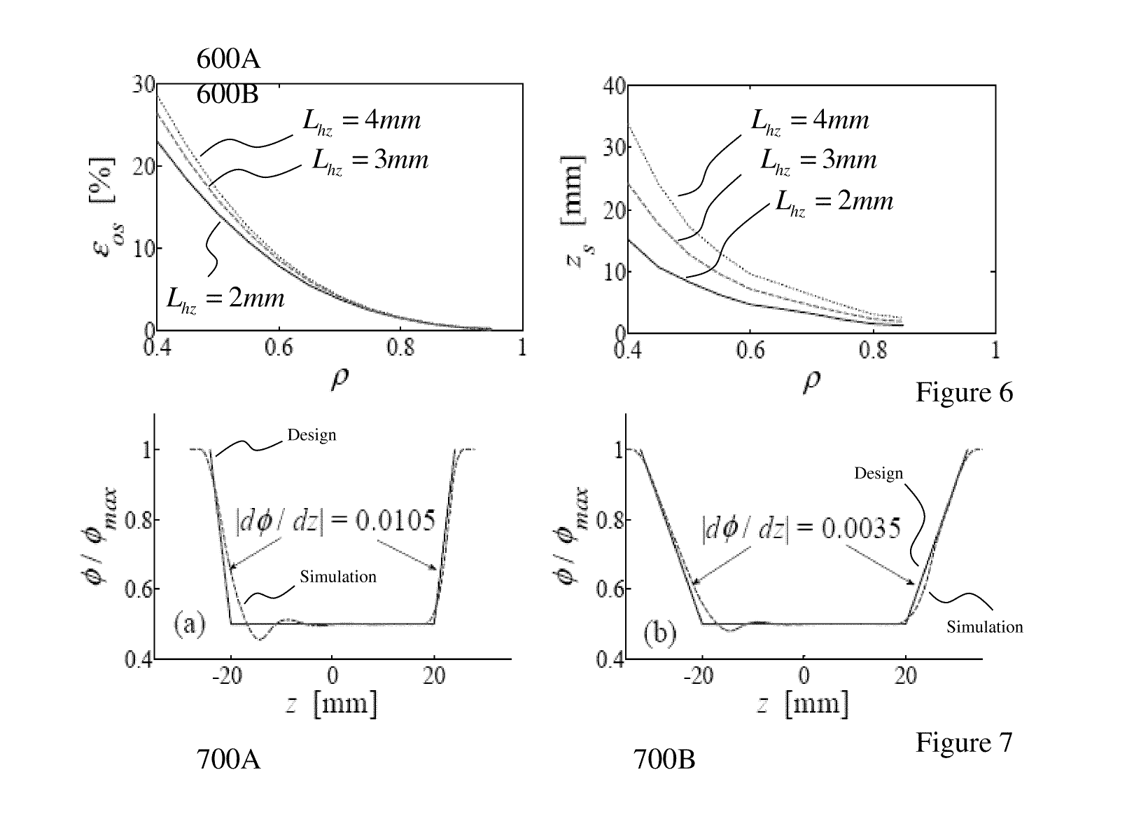

The transient response parameters ε_{OS} and zₛ represent the closeness of the resulting transition shape to the transition design, and the overall mismatch between the target response, step-transition 520, and actual response, transient response 510, is reduced by reducing ε_{OS} and zₛ. Referring to FIG. 6 the simulation results in first graph 600A present the variation of ε_{OS} as a function of L_{HZ} and the inverse transitioning ratio ρ=φₘᵢₙ/φ₀, where φₘᵢₙ is the minimum transition diameter. Second graph 600B presents the variation of zₛ as a function of L_{HZ} and the inverse transitioning ratio ρ. It can be seen from first and second graphs 600A and 600B ε_{OS} and zₛ decrease with increasing ρ (≦1) and shortening L_{HZ}. With respect to optical propagation in the transition, the overshoot in the wire diameter acts as a perturbation that may lead to coupling between the fundamental mode and higher order modes, radiation modes, or reflection modes. The values of ε_{OS} and zₛ also represent the strength and the length of the perturbation region; therefore, a lower ε_{OS} and a shorter zₛ reduces the perturbation impact.

Single-Sweep Tapering Optimization:

The simulation results above in the modeling of a single sweep tapering presented in FIG. 6 showed that ε_{OS} and zₛ decrease when ρ→1 and L_{HZ}→0 mm. Considering applications such as the enhancement of the waveguide nonlinearity require micro-tapers with a wire diameter on the order of 1 μm drawn from initial fibers with a diameter on the order of 100 μm, leading to ρ˜0.01 which is clearly well away from the desired target of a high ρ. Further, L_{HZ} is on the order of 1 mm and is limited by both the temperature distribution in the fiber and the heater dimensions. Moreover, it turns out that ε_{OS} and zₛ decrease when the transition slope decreases. Referring to FIG. 7 it can be see that as the slope, |dφ/dz|, decreases 0.0105 in first graph 700A to 0.0035 in second graph 700B then ε_{OS} decreases from approximately 8.8% to approximately 3.8% and zₛ decreases from approximately 13.5 mm to approximately 11.65 mm. In most cases, however, it is desirable to use the largest slope allowed by the adiabaticity criteria because using a small transition slope to reduce ε_{OS} and zₛ leads to a long transition region and consequently increases the sensitivity of the transition to environmental variations, see for example Birks, as well as increasing the device length. The inventors have shown that ε_{OS} and zₛ can be reduced by transitioning using their generalized heat-brush approach as described below subsequent to the presentation of experimental results of single sweep tapering.

Single Sweep Experimental Setup:

Referring to FIG. 8 there is illustrated the experimental implementation of the single-sweep tapering method where a translation stage 870 moves a heater 840 attached to an arm 860 mounted to the moving plate 880 of the translation stage 870 at a velocity ν_{y}. Also depicted are first and second translation stages 810 and 815 which pull the fiber 850 from opposite directions at equal velocities ν_{w} and νₓ by having the fiber 850 clamped via first and second clamps 830 and 835 to first and second plates 820 and 825 on the first and second translation stages 810 and 815. Using ν_{d}=ν_{y}+ν_{w} and ν_{f}=ν_{y}−νₓ=α, where α is a constant, the velocities of the heater and the translation stages pulling on the fiber at a drawing length l_{d}=y+w are given by Equations 13 and 14. Within FIG. 8 and other figures described below the schematics are for illustration purposes and the relative dimensions of different elements such as core and cladding are not intended to be to scale due to the high ratios of diameter that exist within these embodiments between initial and final optical fiber structures. The figures presented within the descriptions are correct.

$$\begin{matrix}{υ}_{y} ( {l}_{d} ) = \frac{{υ}_{d} ( {l}_{d} ) + {υ}_{f} ( {l}_{d} )}{2} = \frac{α}{2} [ \frac{1}{s ( {l}_{d} )} + 1 ] & ( 13 ) \\ {υ}_{x} ( {l}_{d} ) = {υ}_{w} ( {l}_{d} ) = \frac{{υ}_{d} ( {l}_{d} ) {υ}_{f} ( {l}_{d} )}{2} = \frac{α}{2} [ \frac{1}{s ( {l}_{d} )} - 1 ] & ( 14 )\end{matrix}$$

Single-Sweep Tapering Experimental Results:

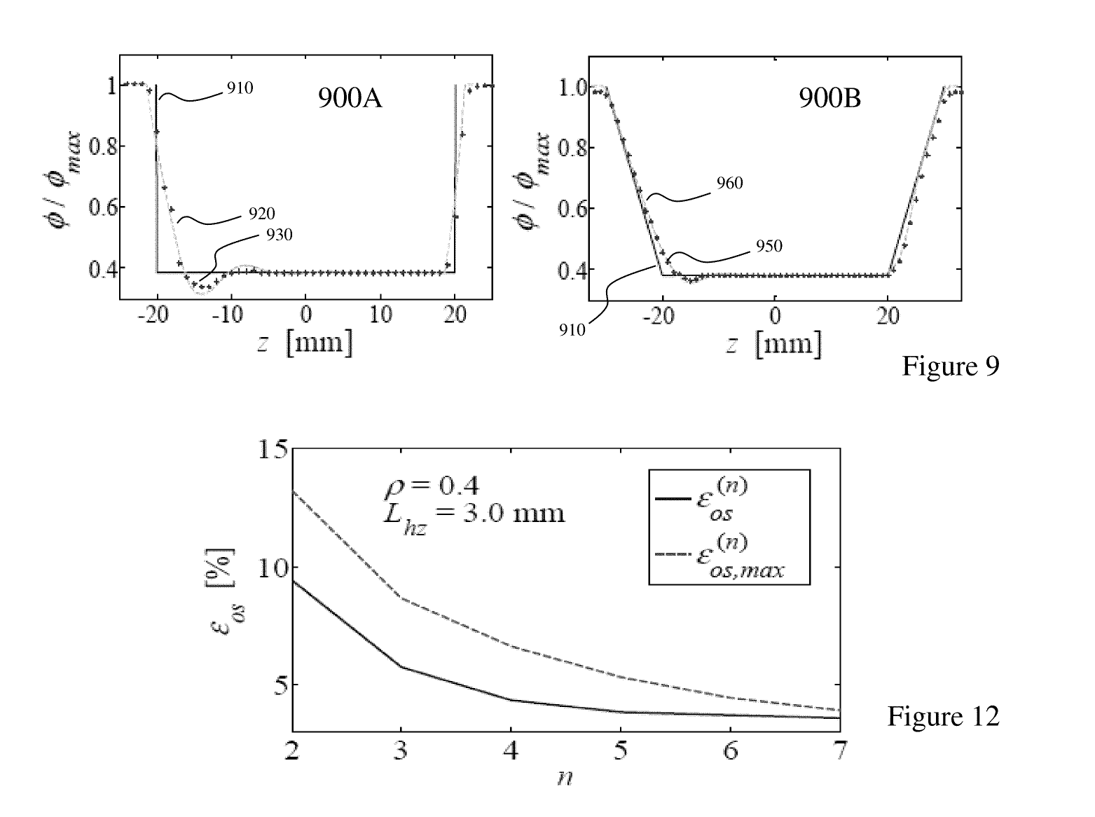

Referring to FIG. 9 the first graph shows the experimental results against a target step-transition profile 910 fabricated using an As₂Se₃ fiber with an initial diameter of 170 μm using a 5 mm long resistive heater at 210° C. with v_{f}=0.72 mm/min and ν_{d}^{mX}=max(ν_{f}/s)=4.5 mm/min. The fabricated transition was removed from the tapering setup and placed straight on a flat plate, and then, an imaging system composed of a 20× lens and a CCD camera mounted on a motorized translation stage used to measure the transition profile with a measurement taken every 1.0 mm. The measured step-transition profile 920 clearly shows an overshoot in the fiber diameter arising from the finite length of the hot-zone and is shown against the initial simulation 930.

An effective hot-zone length of 2.7 mm was retrieved by simulating the step-transition fabrication and fitting the simulation results with the measured profile. The measured effective length was then used to simulate the fabrication of the transition 940 as depicted in second graph 900B wherein the simulation results 960 show good agreement with the experimental results 950 within the measurement error of 1 μm.

Multi-Sweep Tapering (Generalized Heat Brush Method):

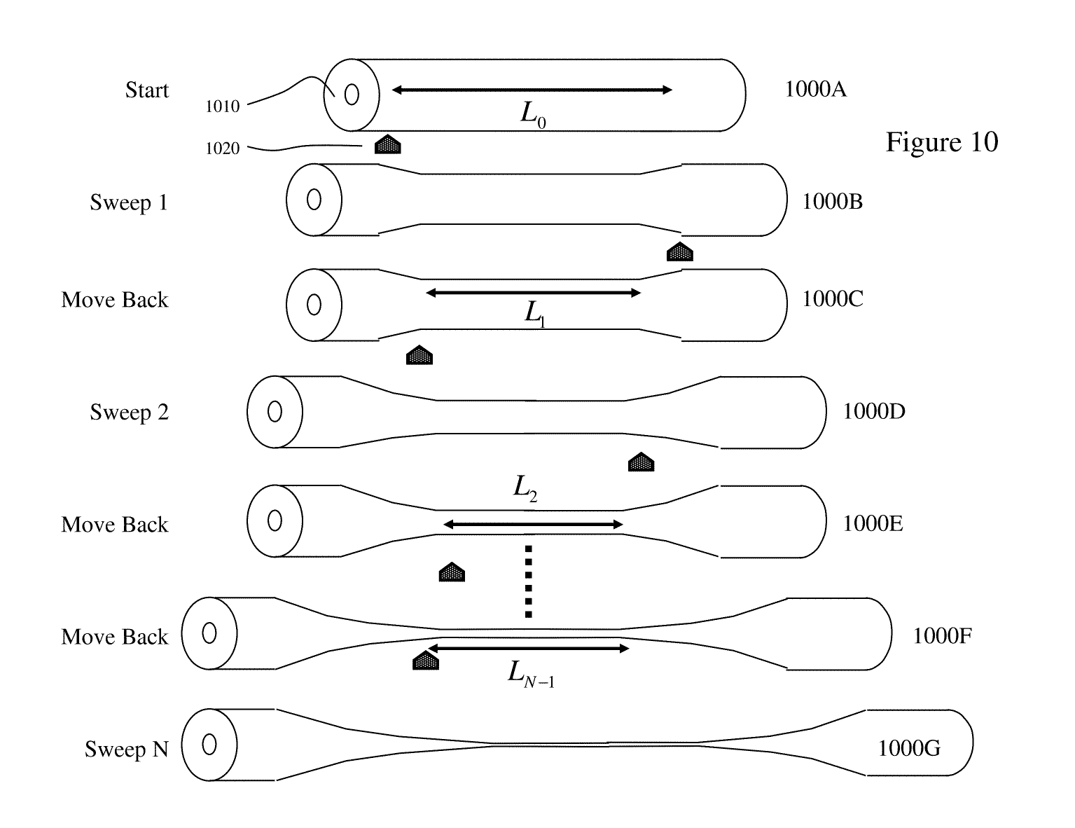

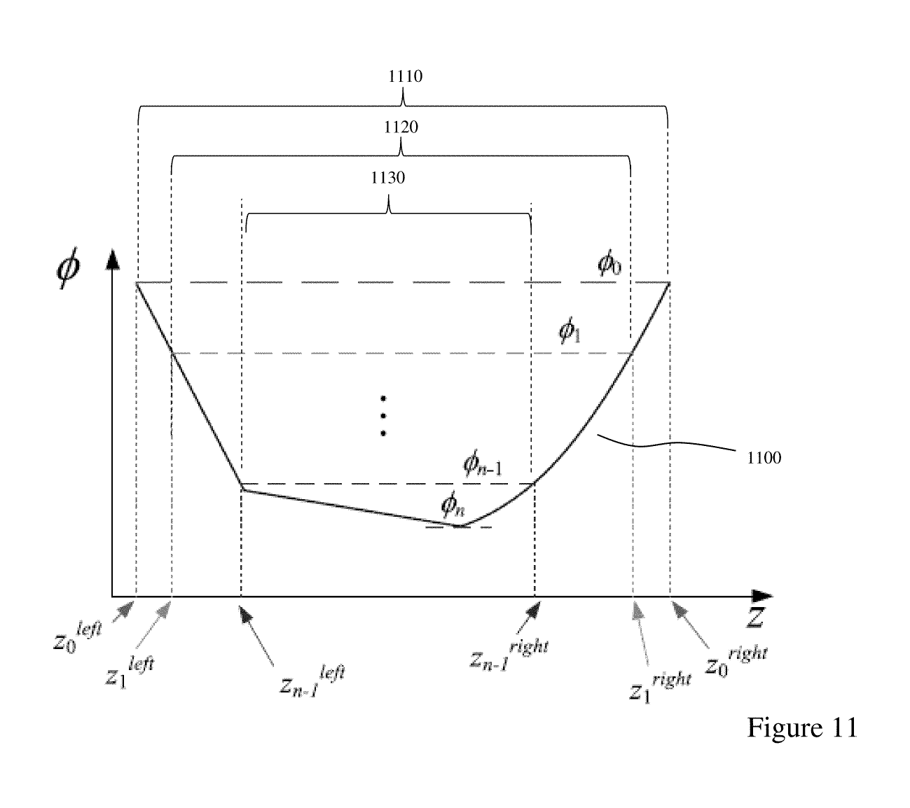

Multi-sweep tapering is performed as illustrated in FIG. 10 representing an implementation of the generalized heat-brush method. To transition a fiber over n sweeps, where the target transition profile 1100 is divided into a plurality of sub-sections 1110 through 1130 as shown in FIG. 11 where φₙ is the minimum transition diameter, φ₀ the initial diameter, and φ₁ to φₙ₋₁ are the wire diameters for the intermediate transitioning sweeps and are calculated using φⱼ=rφⱼ₋₁ with r=ρ^{1/n} and ρ=φₙ/φ₀. For every sweep j<n, the stage transitioning function s^{(j)}(lₚ) is calculated from the stage transition profile φ^{(j)}(z) composed of a left transition region extracted from φ(z) between zⱼ₋₁^{left} and zⱼ^{left}, a right transition region extracted from φ(z) between zⱼ₋₁^{right} and zⱼ^{right}, and a uniform wire φ(j) with a length given by Equation (15).

$${L}_{j} = \frac{{\int }_{{z}_{j}^{left}}^{{z}_{j}^{right}} {φ}^{2} ( z ) d z}{{φ}_{j}^{2}} \qquad ( 15 )$$

where Lⱼ makes the mass volume of the wire at stage j equal to the mass volume required to draw the transition section between zⱼ^{left} and zⱼ^{right}.

The stage transition profile of the final sweep φ⁽ⁿ⁾(z) is extracted from φ(z) between zₙ₋₁^{left} and zₙ₋₁^{right}, and is used to calculate the final stage transitioning function s⁽ⁿ⁾(lₚ). Finally, for each stage j, a single transitioning sweep is performed using the calculated stage transitioning function and then the heater is moved back a distance (zⱼ₋₁^{right},−zⱼ^{right})+Lⱼ.

Quantitative Analysis of Multi-Sweep Tapering:

Based on the divide-and-conquer paradigm, see for example T. H. Cormen et al in “Introduction to Algorithms” (2nd Ed., MIT Press, 2001), tapering a fiber over multiple sweeps reduces the percent overshoot. For a step-transition, the worst-case overshoot diameter at sweep j is estimated using the recurrence relationships in Equations (16) and (17).

φ_{OS}^{(j)}=[1−ε_{OS}(ρⱼ)/100%]×ρⱼ×φ_{OS}^{(j-1)} (16)

φ_{OS}⁽¹⁾=[1−ε_{OS}(ρ₁)/100%]×ρ₁×φ₀ (17)

where εₛ(ρⱼ) is provided in first graph 600A in FIG. 6 for varying hot-zone lengths, L_{HZ}.

By setting the inverse transitioning ratio for all sweeps to r, the worst-case overshoot diameter becomes

φ_{OS}^{(j)}=[1−ε_{OS}(r₁)/100%]^{j}×r^{j}×φ₀ (18)

and the maximum percent overshoot at the end of tapering is

ε_{OS,max}⁽ⁿ⁾=└1−(1−ε_{OS}(r)/100%)ⁿ┘×100% (19)

which is simplified to ε_{OS,max}⁽ⁿ⁾≈nε_{OS}(r) when ε_{OS}(r)≦1%.

It would be evident from first graph 600A in FIG. 6 that ε_{OS,max}⁽ⁿ⁾<ε_{OS} (ρ) and that ε_{OS,max}⁽ⁿ⁾ decreases as n increases. For, example, the fabrication of a step-transition with ρ=0.5 over a single sweep using a 4 mm long hot-zone leads to ε_{OS}(0.5)=17%. However, when transitioning is performed over 6 sweeps with r=0.89 and ε_{OS}(0.89)=0.5%, the maximum percent overshoot is ε_{OS,max}⁽⁶⁾=3%. However, from a manufacturing perspective the use of a large number of sweeps increases the tapering duration thereby decreasing equipment utilization, thereby increasing cost albeit for transitions with increased performance. For the case of a step transition, the minimum time duration for stage j is Tⱼ=Lⱼ₋₁/ν_{f}^{max}, where ν_{f}^{max} is the maximum practical feed velocity, and the total tapering duration after n sweeps is given by Equation (20) which is reduced by increasing ν_{f}^{max} and reducing n. In general, to keep the tapering duration at a minimum, n would be selected so that the minimum number of sweeps is required to keep ε_{OS} below a certain prescribed value.

$$T = \frac{{L}_{0}}{{υ}_{f}^{m ax}} \times \frac{1 - {ρ}^{- 2}}{1 - {ρ}^{- 2 / n}} \qquad ( 20 )$$

Reduced Transition Region Mismatch using Multi-Sweep Tapering:

The transition diameter decreases in steps in the heat-brush implementation of Birks' model, limiting the minimum attainable mismatch between the resulting fabricated taper and the design. At any diameter φ, the diameter step is φ=(1−ρ)φ and the transition slope is approximated by ∂φ/∂z≈Δφ/Δz leading to Δz≈(1−ρ)φ/∂(φ/∂z). Setting L_{HZ}<<|Δz| does not decrease the mismatch because the diameter steps in the transition region become more prominent. But setting L_{HZ}≧|Δz| is practical to keep the transition region smooth. For example, if the length of the brushing-zone is a constant Lₒ, then the transition profile is given by φ(z)=φ₀exp(−z/L₀) (see Birks) and |Δz|≈(1−ρ)L₀.

Using typical values of ρ=0.97 and L₀=2.0 cm leads to |Δz|≈0.6 mm, which requires L_{HZ}≧0.6 mm. In contrast, the diameter steps are eliminated in the multi-sweep tapering method because the transition region is carved within each tapering sweep; therefore, shortening L_{HZ} always reduces the mismatch between the resulting transition and the design.

Multi-Sweep Tapering Simulation:

Multi-sweep tapering simulation was performed by repeated application of the single sweep tapering program discussed above. The simulation results from a multi-sweep tapering simulation performed using L_{HZ}=3 mm for a step-transition with ρ=0.4 are presented in FIG. 12 showing the percent overshoot, ε_{OS}⁽ⁿ⁾, decreasing as n increases. Also shown in FIG. 12 is the worst-case percent overshoot, ε_{OS,max}⁽ⁿ⁾, calculated using Equation (19). It can be seen that ε_{OS,max}⁽ⁿ⁾ does not exceed ε_{OS,max}⁽ⁿ⁾, which is expected as ε_{OS,max}⁽ⁿ⁾ estimates the upper limit of ε_{OS,max}⁽ⁿ⁾.

Although increasing n reduces ε_{OS}, L_{HZ} must also be shortened to ensure that |ε(z)| is less than a prescribed target value ε_{target}. Shortening L_{HZ} becomes increasingly important when the transition profile incorporates “fine” details such as a large ∂φ/∂z, a large change in ∂φ/∂z, or a short wire. For example, if the transition wire length is of the same order as L_{HZ}, then the details of the wire cannot be precisely shaped. The value of L_{HZ} that ensures |ε(z)|<ε_{target} for a given transition profile can be determined through simulations.

Multi-Sweep Tapering Experimental Results:

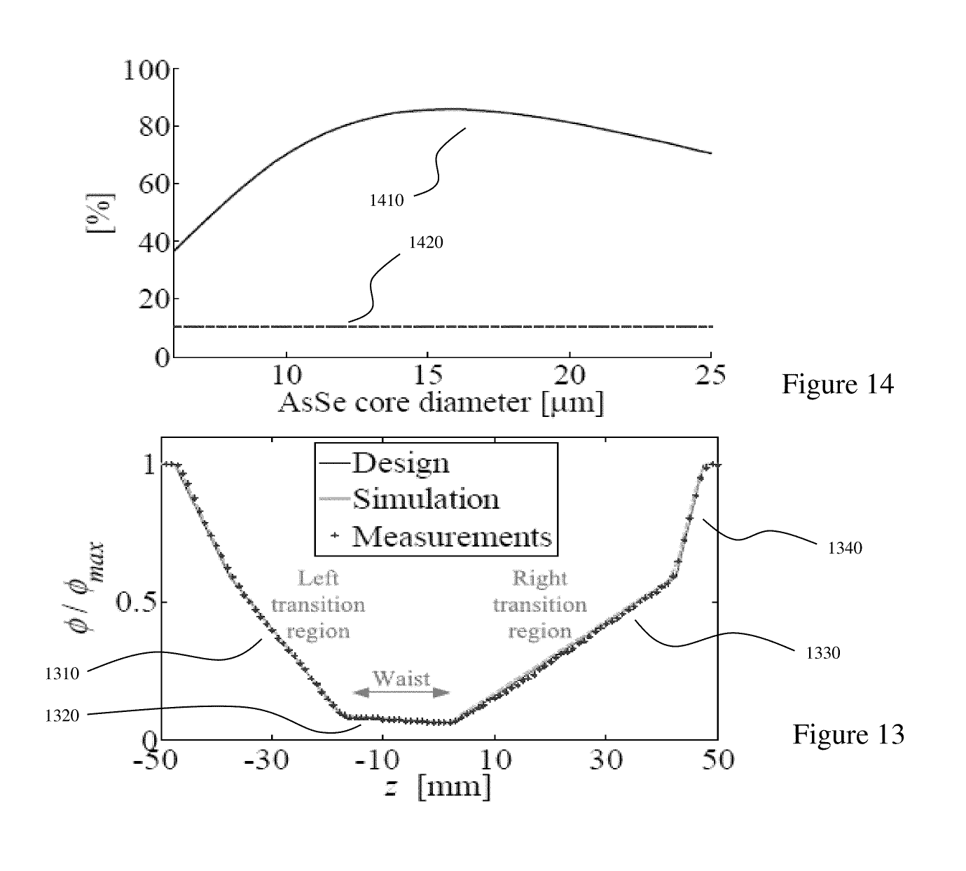

Referring to FIG. 13 there are presented the experimental results for the fabrication of a complex As₂Se₃ taper with an initial fiber diameter of 170 μm, dissimilar transitions comprising left transition region 1310 and right transition region comprising first and second right sections 1330 and 1340 respectively, and a non-uniform wire 1320. The wire 1320 diameter decreasing linearly from 15 μm to 10 μm over a wire length of 20 mm. Left transition region 1310 being non-linear, whilst first and second right sections 1330 and 1340 are linear with second right section 1340 being a relatively steep transition.

The taper was experimentally fabricated over 24 sweeps using the same resistive heater in the single-sweep experiment reported above, operating at 210° C. with ν_{f}=3.56 mm/min and ν_{d}^{max}=4.50 mm/min. The measurement error as before from the optical measurements of the fabricated transition is 1 μm and the resulting taper matches the design within the measurement error.

Hybrid Fiber Tapers:

As discussed above micro-tapers within optical fibers formed from non-linear materials offer ultrahigh waveguide nonlinearity for all-optical processing. For example, these micro-tapers have been fabricated by the inventors using single-mode chalcogenide fibers that are coated with a PMMA layer, see C. Baker et al in “Highly Non-Linear Hybrid AsSe-PMMA Microtapers” (Optics Express, Vol. 18, pp 12391-12398). A single-mode As₂Se₃ fiber was employed as it ensures single-mode propagation in the wire section of the micro-taper given that the transition shape satisfies the adiabaticity criteria. Also, a single-mode As₂Se₃ provides efficient coupling to standard single mode silica-fibers.

However, such micro-tapers require multiple discrete processes to be performed, such as the initial optical fibre preform manufacture, fiber drawing to produce the single-mode As₂Se₃ fiber, application of polymer coating, and subsequently the fabrication of a micro-taper to achieve the desired reduction in the effective area of the optical waveguide for the high non-linearity performance. In production for high yield which leads to reduced costs, high performance, and reproducible performance this requires consistent high quality single-mode As₂Se₃ fiber is produced, which implies high production run fiber lengths are drawn, as evident from the overall yielded fiber versus drawn fiber in production environments for conventional telecommunications single-mode fibers.

Accordingly it would be beneficial in instances where such specialty fibers are being produced solely for the purpose of effecting short high non-linearity optical devices for an optical micro-taper to be produced directly from a preform thereby removing the requirement for the intermediate stage of producing long production lengths of high quality single-mode optical fiber of the specific configuration for the high non-linearity optical fiber. Further, the requirement of the short high non-linearity fiber to interface to standard single-mode optical fiber may conflict with the design requirement of a single-mode optical fiber in that particular material system due to the index contrast, etc of the materials employed. However, it is well known in the art that a non-single-mode waveguide may support sole propagation of a single transverse mode when excited appropriately for short distances such as would be required for the short interface regions between the telecommunications single-mode optical fiber and the ends of the micro-taper.

Further, the direct manufacture of optical fiber/fiber taper/micro-taper in a single manufacturing process allows high non-linearity fibers and their corresponding optical devices such as micro-tapers to be manufactured, prototyped, developed and commercialized without the requirement that a stable single-mode fiber drawing process is established. Accordingly, the method according to embodiments of the invention allows advanced materials research and optical device performance to not only proceed simultaneously but more rapidly than currently possible as now the requirements on the manufacturing of the preform are reduced in terms of the quantity of preform fabricated to evaluate a material system for its optical properties directly in device configurations. It would also be evident to one skilled in the art that the length of optical structures fabricated is determined by simple mechanical constraints of translation stages, their travel range, speed etc. rather than requiring a complex optical fiber drawing tower and associated equipment.

Accordingly, the inventors have demonstrated a novel direct optical fiber/micro-taper manufacturing process exploiting an AsSe-PMMA material system. As such the inventors did not require a single-mode As₂Se₃ fiber but rather started from a preform comprising only an As₂Se₃ core layer and PMMA cladding layer. As discussed above in respect of an AsSe-PMMA micro-taper fabricated from a doped single-mode As₂Se₃ fiber, with 6 μm core and 170 μm outer diameter that had been drawn conventionally prior to forming the micro-taper, the tapering of the wire section of the transition can support single transverse mode signal propagation even when the wire is multimode as the higher order modes spread to the cladding and are either absorbed by the PMMA cladding or are coupled to radiation modes due to the slight bends within the transition wire.

Consequently, the only transmitted mode is the fundamental mode, and the tapered multimode AsSe-PMMA fiber can be used as a single-mode device. It is, however, necessary, however, that the slope of the transition region of the taper satisfies the adiabaticity criteria and that there are no severe bends/steps/transitions within transition region and that the un-transitioned sections of the hybrid fiber to avoid coupling between the fundamental mode and higher order modes. Further, according to embodiments of the invention these optical micro-tapers can be fabricated from a preform that incorporates additional coating layers in addition to the normal core and cladding layers allowing the micro-tapers to be fabricated with enhanced mechanical robustness for normal handling of the micro-taper, reduced sensitivity environmental effects, and reduced surface defects.

Within the descriptions of this specification reference is made below to mono-AsSe-PMMA fiber designs and dual-AsSe-PMMA fiber designs which differ in respect of the number of AsSe compositions employed. The mono-AsSe-PMMA design may also be referred to as a hybrid fiber as the fiber exploits two different materials as opposed to two different compositions of the same material as occurs within the dual-AsSe-PMMA design. Optical fibers of the dual-AsSe-PMMA design approach when drawn are also referred to as hybrid microwires.

Mono-AsSe-PMMA Fiber Design:

A mono-AsSe-PMMA fiber is composed only of an As₂Se₃ core and a PMMA cladding, unlike an AsSe-PMMA fiber as discussed above which exploits an AsₓSe₁₋ₓ core, As_{y}Se_{1-y} cladding, and PMMA coating, wherein typically x≈38-39 and y≈34-36. However, a mono-AsSe-PMMA fiber, due to the high refractive index contrast between the core, n_{AsSe}≈2.8, and cladding, n_{PMMA}≈1.6, is multimode, except as seen below, for micro-taper/wire dimensions of ˜0.6 μm and below rather than core diameters of approximately 6 μm. However, as discussed above an important design criterion for the multi-mode AsSe-PMMA fiber is coupling efficiency between the fundamental mode of an SMF and the fundamental mode of a hybrid fiber. Modeling of the overlap 1410 between the fundamental transverse modes of a mono-AsSe-PMMA fiber with that of Corning SMF-28 is shown in FIG. 14 over a core diameter range of 5-25 μm and indicating optimal coupling is achieved when the As₂Se₃ core diameter of the fiber should be 15.5 μm with a coupling loss of approximately 1 dB. As evident from reflectivity 1420 most of this 1 dB coupling loss is due to the approximately 10% reflectivity between the AsSe, n_{AsSe}≈2.8, and doped silica, n_{SiO2}≈1.45. Clearly, FIG. 14 represents the ideal case coupling and unless care is taken in the alignment and attachment of the two fibers to avoid lateral misalignment, angular misalignment, a gap between the facets of the two fibers, damaged facets, non-planar facets, and angled facets, additional losses will be incurred.

Mono-AsSe-PMMA Microtaper Design:

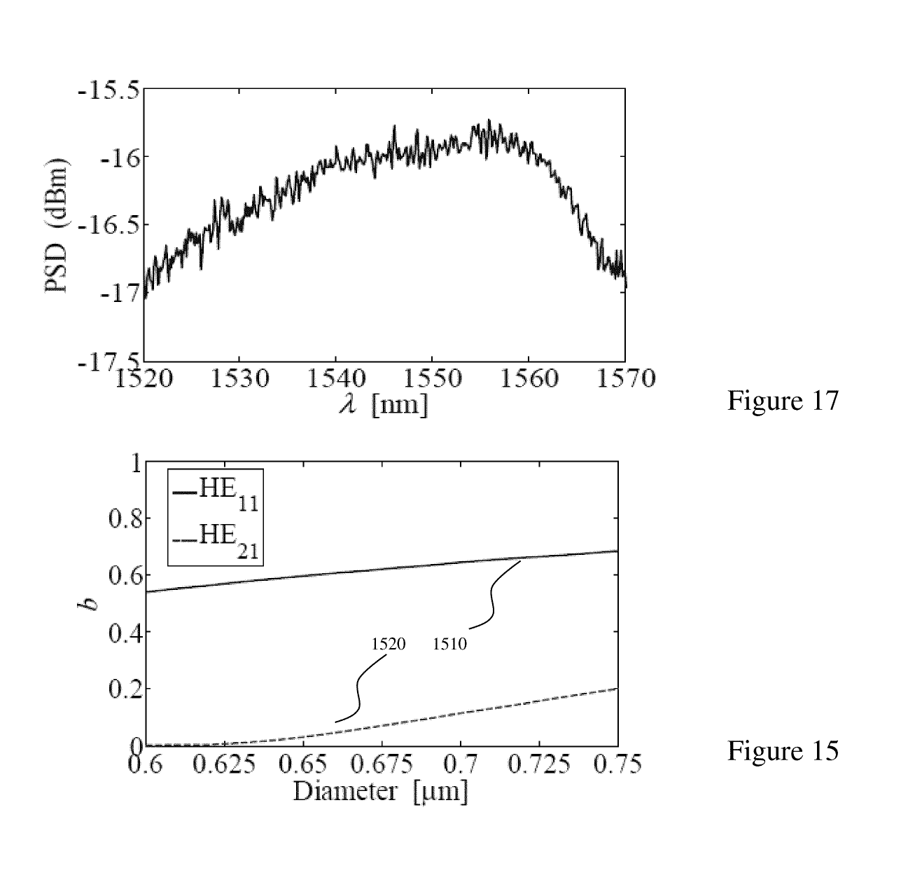

To achieve single-mode transmission in a tapered mono-AsSe-PMMA fiber, the wire section must be single-mode, which given the high index contrast between AsSe and PMMA requires a small diameter wire section. Referring to FIG. 15 there are depicted the normalized propagation constants, b, determined by Equation (21) for both the HE₁₁ and HE₂₁ modes 1510 and 1520 respectively as a function of the As₂Se₃ core diameter. The wire section of the micro-taper becomes single-mode when the As₂Se₃ core diameter is less than 0.625 μm. Single-mode propagation is achieved at V=3 rather than V=2.4 because the wire section does not satisfy the scalar weak-guiding condition due to high refractive index difference between the As₂Se₃ core and the PMMA cladding, Δn=1.38.

b=(n_{eff}−n_{PMMA}²)/(n_{AsSe}²−n_{PMMA}²) (21)

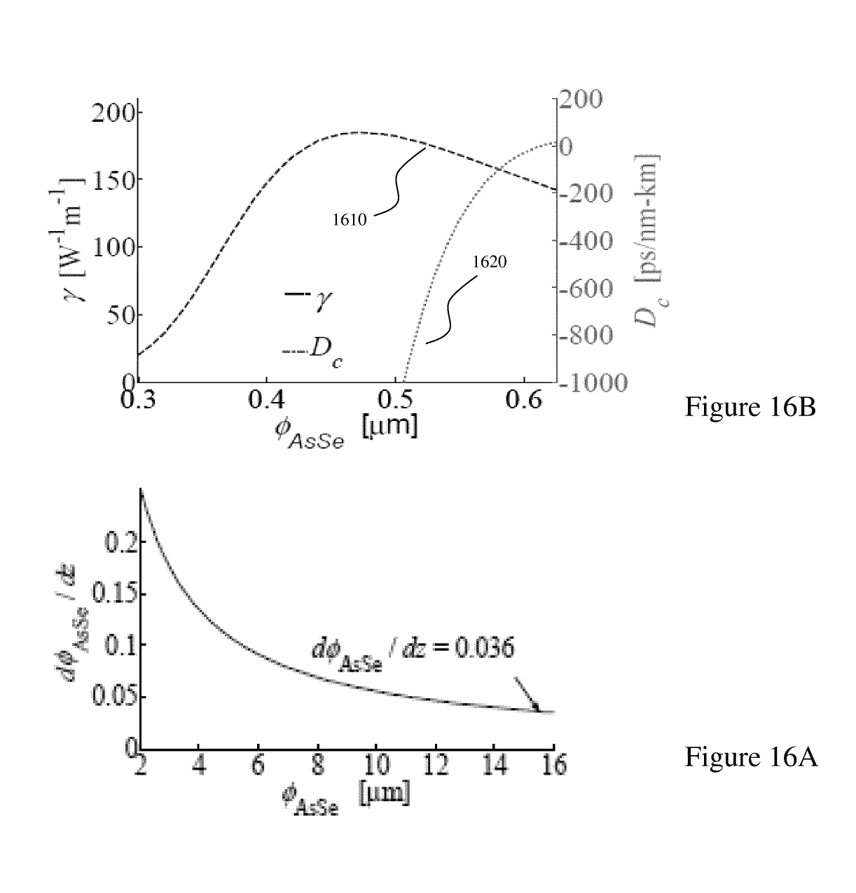

The adiabaticity criteria represents the slope of the transition required to avoid coupling between the modes HE11 and the HE12 is depicted in FIG. 16A and calculated using Equation (22) where β₁₁ is the propagation constant of the mode HE₁₁, and β₁₂ is the propagation constant of the mode HE₁₂. At an As₂Se₃ diameter of 15.5 μm dφ_{AsSe}/dz=0.036.

$$\frac{d {φ}_{AsSe}}{d z} < \frac{{φ}_{AsSe}}{2 π} ( {β}_{11} - {β}_{12} ) \qquad ( 22 )$$

Now referring to FIG. 16B there are presented the results of simulations on micro-tapers using the mono-AsSe-PMMA fiber geometry wherein the resulting optical non-linearity 1610, γ (W⁻¹ m⁻¹) and chromatic dispersion 1620, D_{C} (ps·nm⁻¹·km⁻¹), are plotted against the AsSe wire diameter to determine the maximum allowed transition slope, also known as the delineation line. If the transition slope is made equal to the delineation line, the region over which the transition diameter changes from φ_{AsSe}=15.5 μm to φ_{AsSe}=0.6 μm can be made as short as 1.0 mm. In the fabricated tapers, the slope of transition in the transition region was set to dφ_{AsSe}/dz=φ_{AsSe}/2L₀ with L₀=1 cm.

Mono-AsSe-PMMA Fiber Fabrication:

An As₂Se₃ rod of diameter 170 μm was coated with a PMMA layer of outer diameter 1865 μm and was drawn incrementally at a temperature of 190° C. until the As₂Se₃ core diameter was 15.5 μm and the PMMA coating is 170 μm. The fiber was drawn incrementally because at 190° C. the As₂Se₃ fiber is not soft enough for direct stretching to the desired diameter, however at this temperature the PMMA polymer coating was considerably softened enabling stretching of both materials simultaneously.

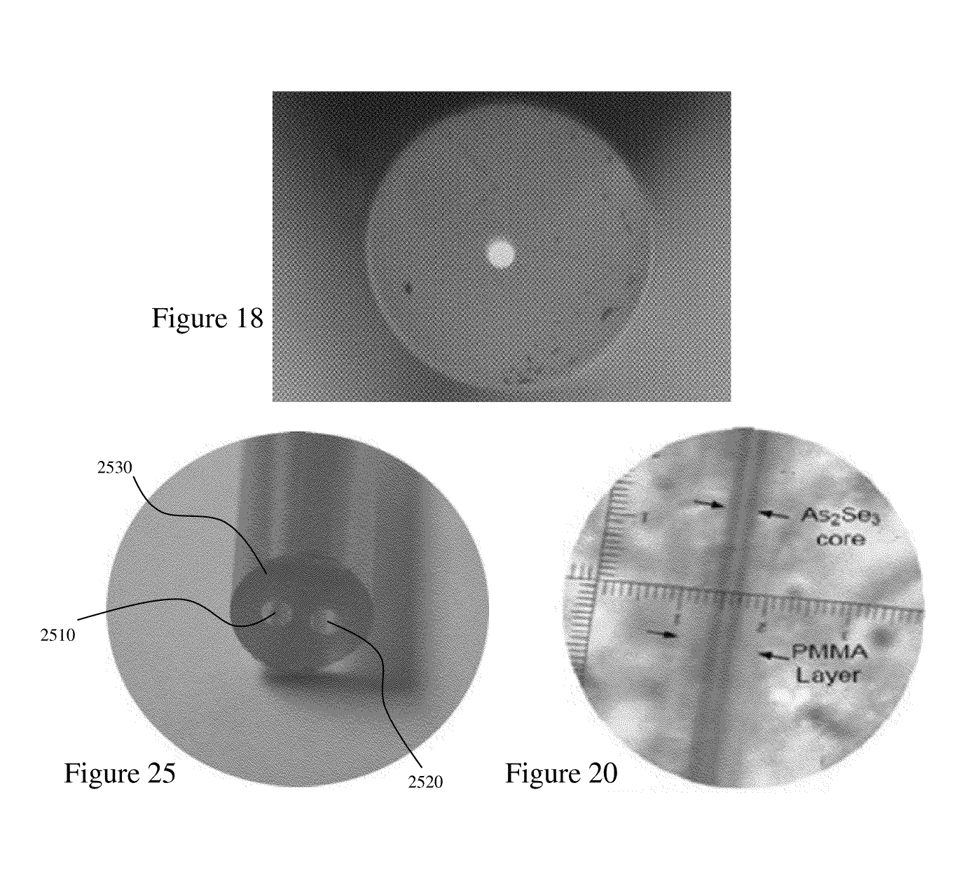

An image of the cross section of the hybrid mono-AsSe-PMMA fiber is shown in FIG. 18 wherein the As₂Se₃ core is clearly visible and surrounded by the PMMA cladding. From the drawn fiber 5 cm long piece were prepared with polishing their end-faces and an ASE broadband noise source launched from an SMF fiber was used to measure the transmission of the hybrid fiber. Due to the multimode nature of the 15.5 μm core an interference pattern with relatively large extinction ratio was evident within the spectrum. Subsequently a 5 cm length of the fiber was processed to form a micro-taper with a wire core diameter of 0.55 μm and cladding diameter 6 μm with a wire section length of 20.0 cm. The transmission through this micro-taper is shown in FIG. 17. Other tapers with a core/cladding diameters of 0.8 μm/8.8 μm and 1.8 μm/19.7 μm were also fabricated. It would be evident that all of these hybrids AsSe-PMMA micro-tapers whilst providing an ultrahigh waveguide nonlinearity also offer sufficient mechanical robustness for normal handling and reduced sensitivity to the surrounding environment.

In order to characterize the linear and nonlinear properties of the hybrid micro-taper a mode-locked laser providing 330 fs full-width at half-maximum pulses at a repetition rate of 20 MHz and at a central wavelength of λ=1552.4 nm was employed. The laser output power adjusted using a variable attenuator and an in-line power meter before injection in the micro-taper. The peak power reaching the As₂Se₃ wire section of the micro-taper was varied up to a maximum of 50 W. Light from the micro-taper output was sent to an optical spectrum analyzer and a power meter. Results from the fibers with core/cladding diameters of 0.8 μm/8.8 μm and 1.8 μm/19.7 μm were γ=147 W⁻¹ m⁻¹ and γ=30 W⁻¹ m⁻¹ respectively. Other single mode mono-AsSe-PMMA micro-wires with diameters of 0.55 μm and 0.6 μm have yielded results of γ=150 W⁻¹ m⁻¹.

Dual-AsSe-PMMA Taper:

As discussed above the inventors have previously reported, see Baker, on the formation of micro-tapers in As₂Se₃ single-mode fiber with a PMMA coating. Accordingly, in contrast to the mono-AsSe-PMMA taper this micro-taper now consists of a first As₂Se₃ portion, of diameter 5.6 μm, a second As₂Se₃ portion of diameter 160 μm, and a PMMA coating that was formed around the As₂Se₃ former by uniformly collapsing a PMMA cylinder with internal/external diameter of 230/1000 μm at 160° C. to uniformly collapse the polymer rod over the modified chalcogenide fiber.

Determination of the optimal micro-taper design involved an analysis of the field propagating in the wire section of the micro-taper, leading to values of waveguide nonlinearity parameter and the chromatic dispersion parameters. Taking into account the discontinuity of the radial component of the electric field at the AsSe-PMMA interface, the vectorial nature of the electric field, and the different material composition of the micro-taper, the effective material nonlinearity and effective area are given by Equations (23) and (24).

$$\begin{matrix}\overline{{n}_{2}} = \frac{{ɛ}_{O}}{{μ}_{O}} \frac{\int {\int }_{∞} {n}_{0}^{2} ( x , y ) {n}_{2} ( x , y ) ( 2 {\vert \vec{E} \vert}^{4} + {\vert \vec{{E}^{2}} \vert}^{2} ) d A}{3 \int {\int }_{∞} {\vert [ \vec{E} \times \vec{{H}^{*}} ] \cdot \hat{z} \vert}^{2} d A} & ( 23 ) \\ {A}_{eff} = \frac{{\vert \int {\int }_{∞} [ \vec{E} \times {\vec{H}}^{*} ] \cdot \hat{z} d A \vert}^{2}}{\vert \int {\int }_{∞} [ \vec{E} \times {\vec{H}}^{*} ] \cdot \hat{z} \vert d A} & ( 24 )\end{matrix}$$

where n₀ is the refractive index (n_{0,AsSe}=2.83, n_{0,PMMA}=1.47), n₂ is the material nonlinearity (n_{2,AsSe}=1.1×10⁻⁷ m² W⁻¹, n_{2,PMMA}=−8×10⁻¹⁹ m² W⁻¹), k₀ is the wavenumber, E and H are the electric and magnetic fields, respectively, ε₀ and μ₀ are the electric permittivity and the magnetic permeability of free space, respectively, z is the direction of propagation and A is the transverse surface area.

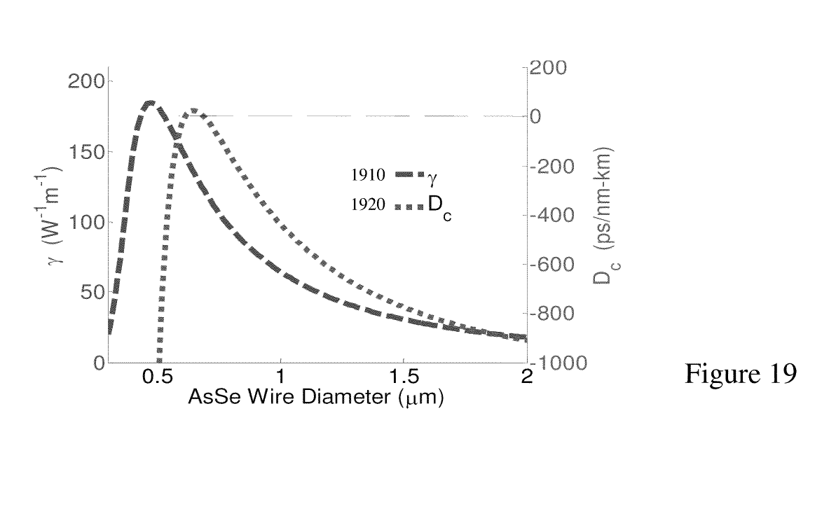

FIG. 19 shows the waveguide nonlinearity parameter 1910 (γ) versus the As₂Se₃ wire diameter at a wavelength of 1550 nm. The maximum waveguide nonlinearity parameter reaches γₘₐₓ=185 W⁻¹ m⁻¹ with an As₂Se₃ wire diameter of 0.47 μm.

For chromatic dispersion calculations, the wavelength dependence of the refractive index for As₂Se₃ and PMMA is calculated using the Cauchy relation in Equation (25)

n²(λ)=A+B/λ²+C/λ⁴ (25)

where A, B, and C are the Cauchy coefficients for the material of interest and λ is the wavelength in μm. For As₂Se₃, A=7.56, B=1.03 μm², and C=0.12 μm⁴ in the range of 0.9 μm≦λ≦1.7 μm, and for PMMA, A=2.149, B=0.028 μm², and C=−0.002 μm⁴ in the range of 0.6 μm≦λ≦1.6 μm. The propagation constant β and the effective refractive index n_{eff}=β/k₀ of the fundamental mode are calculated by solving the characteristic equation of the waveguide with the refractive indexes given above.

Accordingly, chromatic dispersion is then given by Equation (26) and is shown plotted in FIG. 19 as D_{C} 1920 wherein for wire diameters below approximately 0.6 μm D_{C} becomes negative and increases in magnitude severely with decreasing wire diameter and increases in magnitude gradually with increasing wire diameter.

$${D}_{c} = - \frac{λ}{c} \frac{{d}^{2} {n}_{eff}}{d {λ}^{2}} \qquad ( 26 )$$

To simulate pulse propagation in the micro-taper, a split-step Fourier method based on the generalized nonlinear Schrodinger equation was used, see for example G. P. Agrawal in “Nonlinear Fiber Optics” (Academic Press, 2007), as presented in Equation (27).

$$\frac{\partial A ( z , T )}{\partial z} + \frac{1}{2} ( α + \frac{{α}_{2}}{{A}_{eff}} {\vert A ( z , T ) \vert}^{2} ) A ( z , T ) - {\sum }_{k \geq 2} \frac{{j}^{k + 1}}{k !} {β}_{k} \frac{{\partial }^{k} A ( z , T )}{\partial {T}^{k}} = j γ ( 1 + \frac{j}{{ω}_{0}} \frac{\partial }{\partial T} ) [ A ( z , T ) {\int }_{- ∞}^{T} R ( T - {T}^{′} ) {\vert A ( z , {t}^{′} ) \vert}^{2} d {T}^{′} ] \qquad ( 27 )$$

where A(z,T) is the electric field envelope as a function of distance z along the fiber and time T with respect to the moving frame of reference.

The parameter ω₀ is the angular carrier frequency, βₙ(ω₀) is the nth propagation constant derivative at angular frequency ω₀. Parameters α and α₂ are the linear and two-photon absorption coefficients. The nonlinear response function R(t)=(1−f_{R})δ(t)+f_{R}h_{R}(t) includes both the instantaneous δ(t) Kerr contribution and the delayed Raman contribution h_{R}(t)=[(τ₁²+τ₂²)/(τ₁τ₂²)]exp(−t/τ₂)sin(t/τ₁), where τ₁=23.3 fs, τ₂=230 fs, and f_{R}=0.1. Within the simulations, the pulse was propagated in the SMF fiber as well as in the hybrid micro-taper, transition region and wire section, each with appropriate values of γ and D_{C}. No higher order of β than β₃ was required to ensure a good agreement between experiment and theory.

Linear losses in the hybrid micro-taper arise from various origins: butt-coupling losses, material absorption losses, and adiabaticity losses. Butt-coupling losses occur at the SMF/As₂Se₃ fiber interfaces due to mode mismatch and Fresnel reflection (0.5 dB per interface). Material losses in the wire section are derived from Equation (28) where the confinement factor Γᵢ=Pᵢ/Pₜₒₜ with Pᵢ being the power fraction of the mode in layer i and Pₜₒₜ the total power of the mode. The attenuation coefficients in AsSe and PMMA at a wavelength of 1550 nm are α_{AsSe}^{dB}=0.0085 dB/cm and α_{PMMA}^{dB}=0.5 dB/cm, respectively. Finally, adiabaticity losses may occur in the transition regions where the mode from the single mode AsSe fiber is converted into a wire mode, and back into a single mode AsSe fiber mode.

α_{hybrid}^{dB}=Γ_{AsSe}×α_{AsSe}^{dB}+Γ_{PMMA}×α_{PMMA}^{dB} (28)

Dual-AsSe-PMMA Taper Fabrication and Characterization:

The micro-taper was fabricated using the same principles as described above in respect of the mono-AsSe-PMMA fiber and micro-taper in that a heater at 190° C. was used and the assembly adiabatically drawn so that the As₂Se₃ wire section of the hybrid micro-taper reached the target diameter. A first micro-taper was formed for a wire section length of 7.0 cm and As₂Se₃ wire diameter of 1.8 μm with the PMMA cladding having a diameter of 5.4 μm and is depicted in FIG. 20 by an optical micrograph. A second micro-taper was also fabricated with a length of the wire section now 9.7 cm wherein the As₂Se₃ wire diameter was 0.8 μm and the PMMA 2.4 μm. In each instances the PMMA coating allowed the samples to be handled without damage.

Dual-AsSe-PMMA Taper Evaluation:

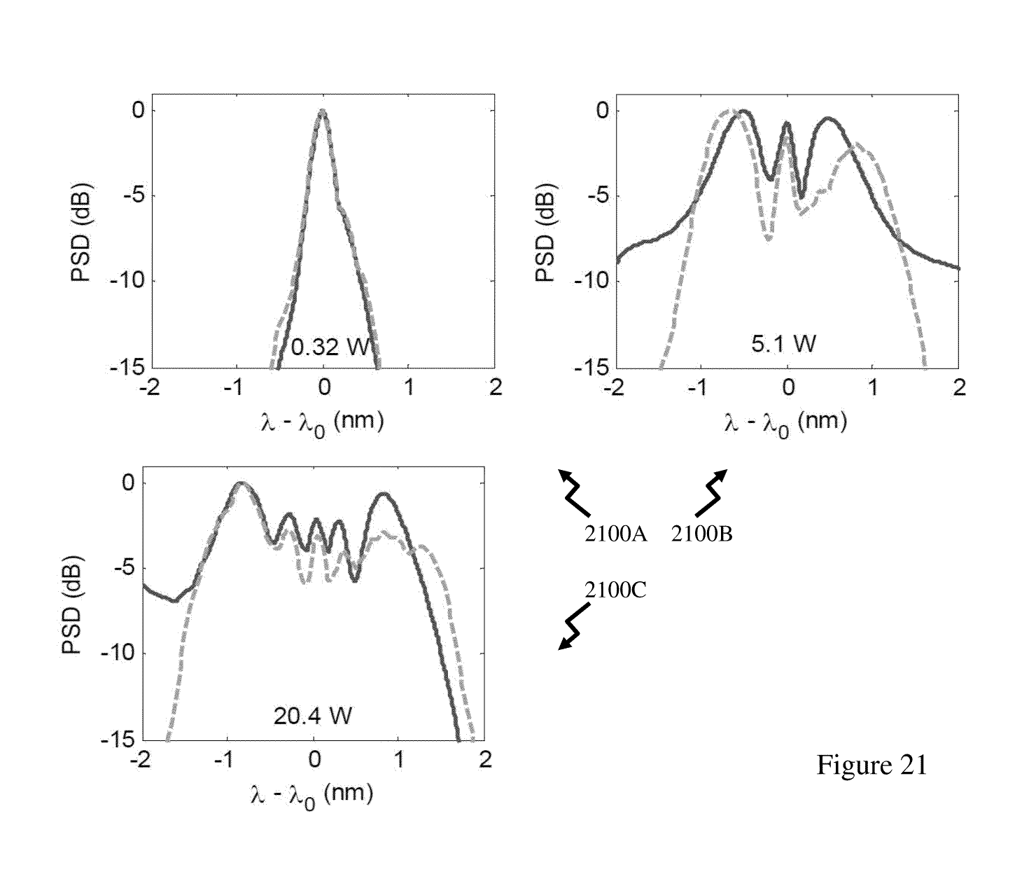

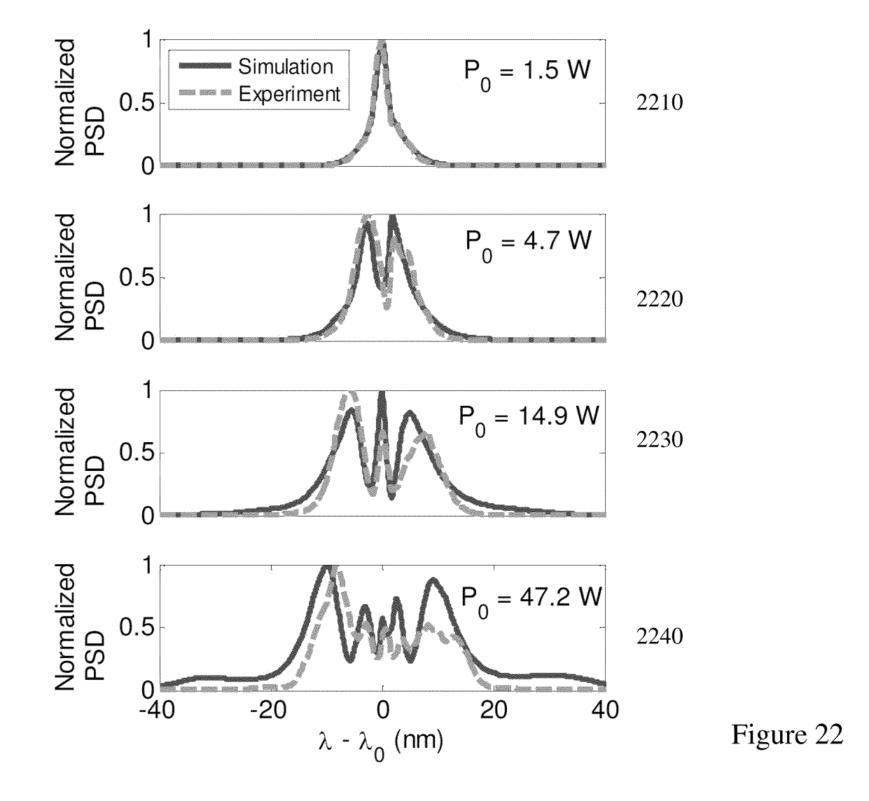

As above a 1552.2 nm mode-locked laser with pulses of 330 fs FWHM at a repetition rate of 20 MHz was used to characterize the fabricated micro-tapers. FIG. 21 presents the measured optical spectrum of pulses for the first hybrid micro-taper at increasing peak power levels of 0.32 W, 5.1 W, and 20.4 W in first to third graphs 2100A to 2100C respectively. The split-step Fourier method was used to fit the experimental data with good agreement and leading to γ_{WIRE}=22 W⁻¹ m⁻¹, A_{eff}=1.4 μm², D_{C}=−950 ps/nm−km (β₂=1210 ps²/km), β₃=2.2 ps³/km. The wire section of the first micro-taper propagates approximately 100% of the optical signal with no significant fraction in the PMMA, thus leading to a linear attenuation coefficient of α_{hybrid}^{dB}=0.0085 dB/cm. The measured value for γ_{WIRE} represents the value in the wire section of the micro-taper, where 93% of the nonlinear phase-shift accumulates with the remaining 7% is accumulated in the transition regions of the micro-taper near the wire section.

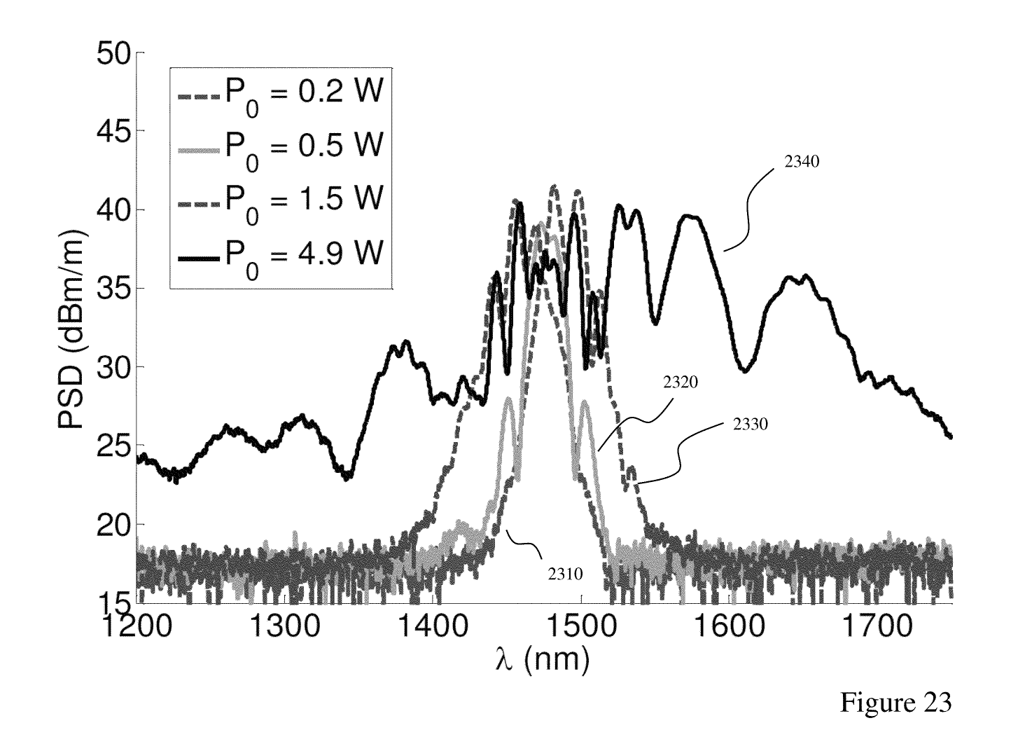

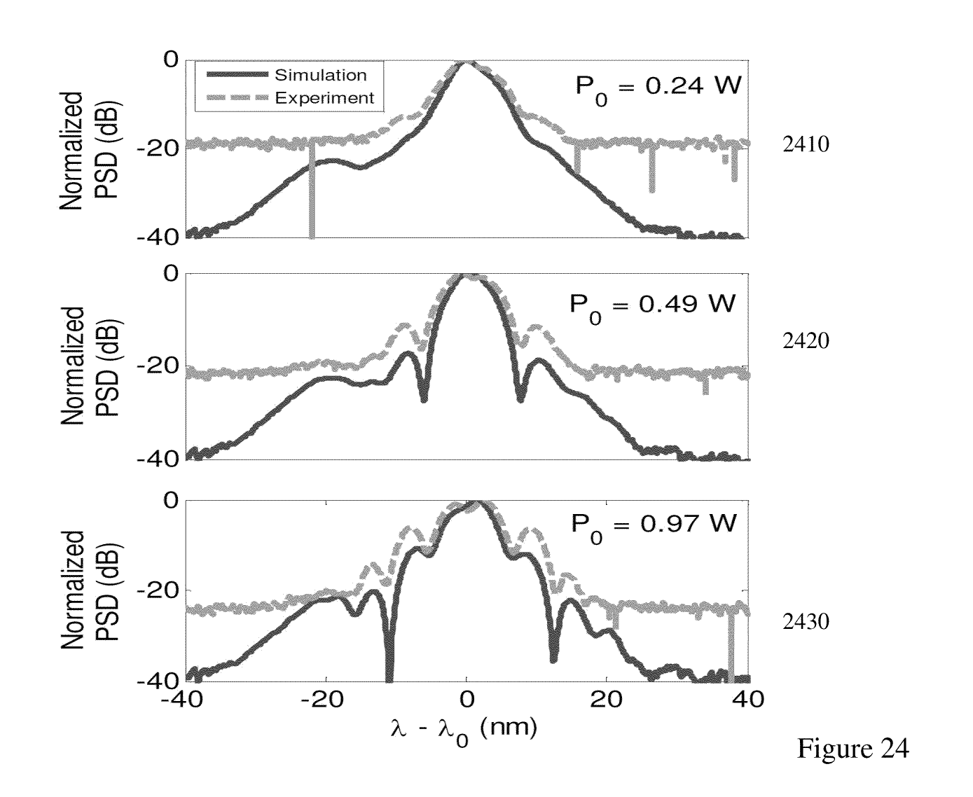

FIG. 23 there are shown the output spectra of the second hybrid micro-taper at optical powers of 0.2 W, 0.5 W, 1.5 W, and 4.9 W respectively for traces 2310 through 2340 respectively. In this case, a supercontinuum is observed with a 20 dB spectral width greater than 500 nm. The split step Fourier method yielding γ_{WIRE}=133 W⁻¹ m⁻¹, D_{C}=−160 ps/nm−km (β₂=205 ps²/km), β₃=3.8 ps³/km, A_{eff}=0.34 μm² and a loss of α_{hybrid}^{dB}=0.018 dB/cm to simulate pulse propagation in the micro-taper as shown in first to third graphs 2510 to 2530 in FIG. 25 at simulated powers of 0.24 W, 0.49 W, and 0.97 W respectively.

Linear losses of the first and second hybrid micro-tapers were 10.5 and 12 dB, respectively. The device losses were constant before and after forming the micro-tapers leading to the conclusion that the mode compression/dilatation at the input/output transition sections of the micro-tapers were indeed as designed, namely adiabatic. The main loss mechanism of these two samples is the coupling loss at the interface of the hybrid fiber and the SMF fiber. This loss may be unevenly distributed at both facets, the loss induced at each facet is inferred by comparing the non-linear spectral broadening taken with the signal propagating in either direction in the device.

The dual-AsSe-PMMA hybrid optical fibers and micro-tapers yielded waveguide nonlinearity parameters of γ_{WIRE}=22 W⁻¹ m⁻¹ and γ_{WIRE}=133 W⁻¹ m⁻¹ for As₂ Se₃ wire diameters section of 1.8 μm and 0.8 μm respectively. Mono-AsSe-PMMA hybrid optical fibers and micro-tapers at the same As₂Se₃ wire diameters achieved γ_{WIRE}=30 W⁻¹ m⁻¹ and γ_{WIRE}=147 W⁻¹ m⁻¹ respectively, increases of approximately 35% and 10% respectively, although these increases are not solely through geometric differences. From simulations the maximum waveguide nonlinearity parameter could be increased up to γ=185 W⁻¹ m⁻¹. With such a large waveguide nonlinearity parameter, a 7 cm hybrid micro-taper could replace the commercially available highly non-linear silica fiber (γ≈0.01 W⁻¹ m⁻¹) of length 1.0 km.

Soliton Self-Frequency Shift:

Soliton self-frequency shifting (SSFS) arises as the soliton propagating in a Raman-active medium such as silica is continuously red-shifted because the low frequency end of the soliton spectrum experiences Raman gain at the expense of the high-frequency end. SSFS is naturally very sensitive to the linear and nonlinear properties of the optical fiber, see for example J. P. Gordon in “Theory of the Soliton Self-Frequency Shift” (Opt. Lett., Vol. 11, pp 662-664). For example a SSFS of 740 nm has been realized in a non-uniform micro-wire of length 20 cm when excited with a seed pulse at a wavelength of 2290 nm and duration of 29 fs, see A. Al-Kadry et al in “Mid-Infrared Sources Based on the Soliton Self-Frequency Shift” (Proc. SPIE, Photonics North 2011).

Such a large wavelength shift was attributed to the small mode confinement, the intrinsic high nonlinearity and appropriate dispersion tailoring of the As₂Se₃ micro-wire under consideration. However, the tight confinement of the field leads to a stronger effect of the higher order chromatic dispersion that decelerates the rate of the shift. A higher order dispersion effect plays also a significant role in this process, in the sense that emits dispersive waves (DW) and thus transfers the energy from the soliton into normal dispersion region. Although the reported non-uniform micro-wire design is efficient in avoiding DW emission, see A. Al-Kadry, the influence of higher order dispersion should be taken in consideration for optimizing the SSFS spectral extent in tapered fibers.

When an ultrashort femtosecond pulse is used as a pump in an optical amplifier such as distributed Raman amplifier, avoiding the dispersive wave emission becomes more difficult to attain. The frequency of the radiation emitted by the soliton in terms of DWs can readily be obtained from a phase-matching condition involving the linear and nonlinear phase change of the soliton, see for example N. Akhmediev et al in “Cherenkov Radiation Emitted by Solitons in Optical Fibers” (Phys. Rev. A, Vol. 51, pp 2602-260′7). Accordingly, a careful and properly designed non-uniform wire may induce a unique dispersion profile at which DW emission is suppressed at the output. Alternatively, SSFS has been shown to be cancelled through the use of negative dispersion slope optical fibers. Cancellation of the frequency shift arises because of the exponential amplification and subsequent saturation of the new radiation band red-shifted with respect to the soliton and emitted by the soliton itself through the Cherenkov mechanism.

Considering, DW emission the inventors have shown that an analytic expression based on the nonlinear Schrodinger equation (NSE), see Gordon, can be used to study the influence of the third order dispersion on the rate of soliton shifting and accordingly demonstrate an efficient and convenient method of controlling the fiber linear property by adjusting a threshold condition on the magnitude of the group-velocity-dispersion. This is achieved by adjusting a threshold condition using a variable

$$ɛ ( z , \overline{δ} ) = \frac{\vert {β}_{3} \vert}{\vert {β}_{2} \vert} τ ,$$

where z is fiber length and δ̅ is the central carrier wavelength, which quantifies the perturbation induced by the third order dispersion on a soliton of duration τ( δ̅) propagating per unit fiber length.

Accordingly, a fundamental soliton propagating in a non-uniform As₂Se₃ micro-wire surrounded by a PMMA cladding is weakly perturbed by β₃ whenever ε(z,\tilde{δ})<0.1. Hence, with the appropriately designed As₂Se₃ micro-wire taper to achieve this phase matching condition the fundamental soliton will not emit significant DW. Similarly, appropriate micro-taper design in conjunction with the appropriate materials for core-cladding of an optical fiber may be fabricated to cancel the red-shift through high negative dispersion.

It would be evident to one skilled in the art that the ability to implement arbitrary profiles within the micro-tapers such that the input and output transitions are different would allow for optical micro-tapers according to embodiments of the invention to be designed to couple with low loss to different optical fibers at the input and output. Further according to the characteristics of the preform from which the one or more optical fibers are drawn from the cross-section of elements within the optical fiber/fiber taper/micro-taper may be symmetric or non-symmetric.

As discussed in respect of standard telecommunication fibers above the preform from which an optical fiber/fiber taper/micro-taper can be made using many techniques known to those skilled in the art. However, as evident below the available techniques may be expanded and modified as manufacturing the optical fiber/fiber taper/micro-taper in a single manufacturing sequence according to embodiments of the invention allows them to be produced with significantly less preform than conventional prior art techniques. Accordingly, amongst the techniques that can be employed include, but are not limited to chemical vapor systems such as modified chemical vapor deposition (MCVD), outside vapor deposition (OVD), plasma activated chemical vapor deposition (PCVD), plasma enhanced chemical vapor deposition (PECVD), chemical solution deposition (CSD), and vapor axial deposition (VAD) as well as epitaxial growth systems such as liquid phase epitaxy (LPE), metal organic chemical vapor deposition (MOVPE), and molecular beam epitaxy (MBE) and evaporation systems such thermal evaporation and electron beam evaporation. Other techniques that may be employed include sputtering, laser ablation, cathodic arc deposition, electrohydrodynamic deposition, and reactive sputtering. Alternatively the materials may be spray coated, spin coated, or dip coated.

In some embodiments of the invention as the technique allows use of relatively small volumes of the preform these preforms may have diameters greater than their length unlike conventional glass fiber preforms. Optionally, in order to achieve not only a micro-taper having variable cross-section geometry but an optical device with a varying longitudinal refractive index profile, doping profile, or other characteristic the deposition processes may be employed to provide varying materials and/or concentrations for example longitudinally as well as radially. In many instances deposited layers of vaporized raw materials may be deposited in the form of a soot and soot layers may be consolidated with additional thermal processing stages which may be performed during the overall preform manufacturing process or upon completion of the deposition processes.

It would also be evident that preforms may be provided through a combination of one or more preforms with another element wherein the preform(s) are inserted into voids or openings within the other element. Such elements may be formed by the above identified techniques as well as others, including but not limited to, casting and extrusion. Alternatively, the preforms may contain voids containing a fluid such as air for example.

It would also be apparent that portions of the preform and/or the entire preform may be radially non-symmetric and have predetermined cross-sections to impart directional variation in the resulting optical fiber/fiber taper/micro-taper geometry to impart different refractive indices, confinement, effective index for example to TE and TM polarisations.

It would be evident that the preform may be fabricated within a single system in some instances or require the use of multiple systems in other instances according to the materials selected for the preform and their manufacturing parameters.

It would also be evident to one skilled in the art that more complex optical fiber geometries and optical tapers/micro-tapers may be fabricated according to the methods described above in respect of embodiments of the invention. For example, two or more optical preforms or elements to form an optical fiber may be formed within a matrix or coating such that upon formation of the structure is achieved under heating and pulling. It would be further evident that the materials employed in each optical the multiple preforms or elements may be varied according to the particular optical device being fabricated. An example of such a combined preform is shown in FIG. 25 wherein first and second optical preforms 2510 and 2520 are shown within a coating 2530.

Integrated Manufacturing:

It would be evident to one skilled in the art that the invention provides for the generation of arbitrary transition profiles within an optical material system allowing for an integrated manufacturing sequence wherein a manufacturer can design and carve an optical fiber with integrated optical taper/micro-taper from a preform in a single carving process.

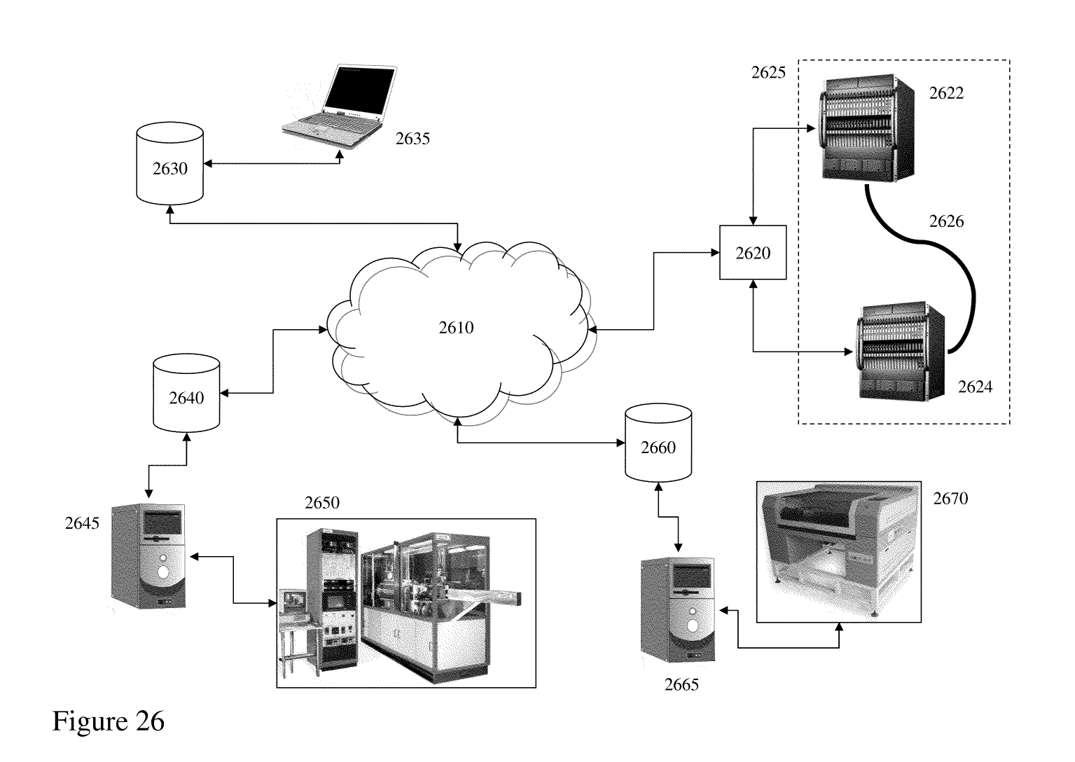

Referring to FIG. 26 there is depicted a schematic of a telecommunications system and manufacturing with respect to manufacturing an optical device specific to the requirements of the telecommunications system according to an embodiment of the invention. Accordingly, an optical telecommunication link 2625 is shown comprising transmitter head-end 2622, optical fiber 2626 and receiver head-end 2624. Coupled to the transmitter head-end 2622 and receiver head-end 2624 is test interface 2620 which upon installation of the optical telecommunication link 2625 performs an analysis of the system performance. From this the test interface 2620 determines the optical performance of the optical telecommunication link 2625 and the requirements for the non-linear optical elements within the optical telecommunication link 2625, which are not shown for clarity. This optical performance for the non-linear elements is communicated via a network 2610 to a first server 2630.

First server 2620 is connected to modeling station 2635 wherein a simulation and modeling of the required non-linear element are performed to generate a preform template and a carving template which are communicated to second and third servers 2640 and 2660 respectively. The preform template is then extracted by preform controller 2645 from the second server 2640 and used by the preform controller 2645 to control the preform system 2650 in order to generate the required preform.

Optionally, the modeling station 2635 may execute the simulation and modeling of the required non-linear element against a library of available preforms to determine whether an acceptable match exists allowing use of an existing preform from inventory which depending upon the physical stock of the manufacturer may trigger the manufacturing of an additional preform on preform system 2650. The carving template is extracted by carving controller 2665 from the third server 2660 and used by the carving controller 2665 to control the carving system 2670 in order to generate the required optical fiber with integrated fiber taper/micro-taper according to the carving template such that the fabricated optical element provides the desired characteristics for the optical telecommunication link 2625 to operate within specification.

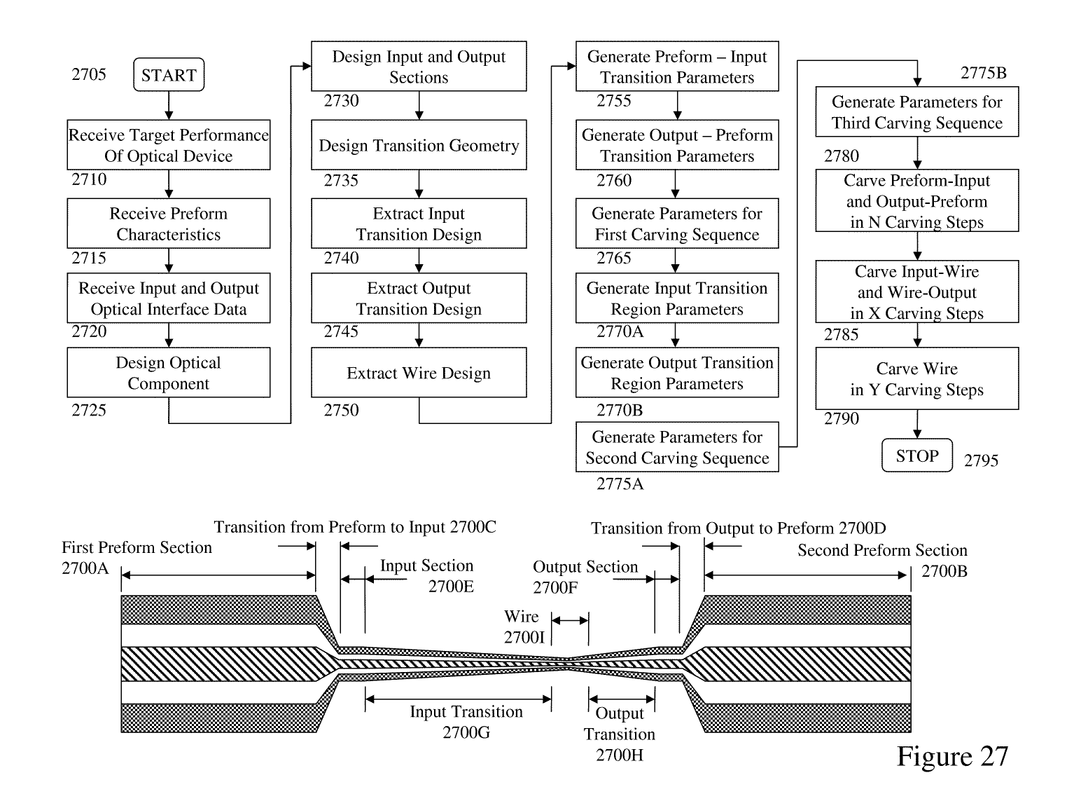

Referring to FIG. 27 there is depicted an exemplary process flow according to an embodiment of the invention for designing and carving an optical fiber with integrated optical taper/micro-taper from a preform, such as that executed by modeling station 2635 in FIG. 26 to generate the preform template and carving template. As noted previously FIG. 27 and other figures described within the schematics are for illustration purposes and the relative dimensions of different elements such as core and cladding are not intended to be to scale due to the high ratios of diameter that exist within these embodiments between initial and final optical fiber structures but have dimensions as specified within the respective descriptions. For example, a dual-AsSe-PMMA fiber may initially have an As₂Se₃ core of diameter 7 μm, As₂Se₃ cladding of diameter 175 μm, and PMMA coating of diameter 1000 μm wherein after micro-taper formation the As₂Se₃ cladding has been reduced to 0.8 μm for example such that the As₂Se₃ core has been reduced to 32 nm (0.032 μm) and the PMMA coating to approximately 4.57 μm.

As shown an optical fiber with integrated optical taper/micro-taper manufactured directly from a preform is shown after manufacturing prior to removal of the optical fiber with integrated optical taper/micro-taper. As shown there is a first preform section 2700A and second preform section 2700B which represent the remaining portions of the preform after the carving process. There are also the transitions from preform to input 2700C and output to preform 2700D that transition from the preform to the input section 2700E and output section 2700F, which for example may be sections of constant 125 μm outer diameter sections for fusion splicing to standard Corning SMF-28 fiber that has a 125 μm outer diameter. Also shown are input transition 2700C, output transition 2700H, and wire 2700I.

Referring to the process flow the process starts at step 2705 before progressing to step 2710 where target performance of the optical device is obtained, for example from a target specification of a component or from measured system characteristics. Next at step 2715 the preform characteristics are retrieved alongside the input and output optical interface data in step 2720 such that in step 2725 the optical component can be designed overall such that then in steps 2730 through 2750 the input and output sections, transition geometry, input transition design, output transition design and wire design respectively are determined. Using this data in steps 2755 and 2760 the preform-input transition and output-preform transition parameters are determined such that in step 2765 the first carving sequence to form an optical fiber from the preform is derived.

Next in steps 2770A and 2770B the input transition and output transition region parameters are derived such that in step 2775A the second carving sequence to form the transitions of the fiber taper/micro-taper are derived and then in step 2775B the third carving sequence for carving the wire, if there is one, are derived. Accordingly, the process proceeds to step 2780 wherein the first carving sequence is performed in N carving steps, then to step 2785 wherein the second carving sequence is executed in X carving steps, and then to step 2790 wherein the third carving sequence is executed in Y carving steps, after which the process moves to step 2795 and stops. The number of carving steps N, X, and Y may be predetermined for example from manufacturing constraints of production speed etc or established from the modeling and design sequence to reduce errors below predetermined thresholds etc.

It would also be evident that the exemplary process flow in FIG. 27 may be combined with an optical modeling process flow such that an initial carving sequence and resulting transition profile is then simulated for the resulting optical characteristics and performance such that one or more parameters within the exemplary process flow of FIG. 27 may be adjusted, such as for example the heater length, translation stage speeds, number of carving sweeps etc, such that the combined flows iterate to a manufacturing process that meets predetermined criteria. Such criteria for example being, to achieve shortest overall optical fiber/fiber taper/micro-taper length, shortest manufacturing time, and maximum wire diameter consistent with target performance.

Alternatively, as discussed in FIG. 26 the exemplary process flow in FIG. 27 may be employed in conjunction with a preform design process flow to similarly iterate the design of the overall optical fiber/fiber taper/micro-taper to achieve predetermined criteria on the manufacturing sequence, such as avoiding particular doping regimes, particular material combinations, etc.

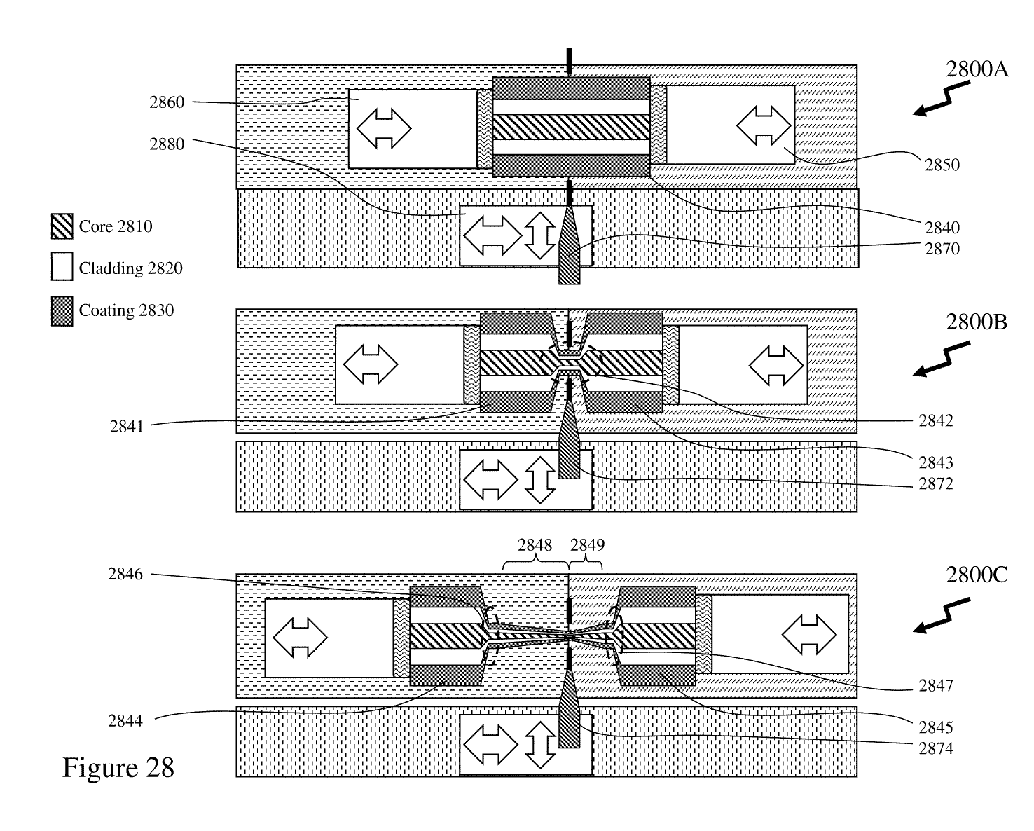

Now referring to FIG. 28 there is shown an exemplary manufacturing sequence according to an embodiment of the invention for carving an optical fiber with integrated optical taper/micro-taper from a preform such as discussed above in respect of FIG. 27 wherein multiple carving sequences were established. Accordingly, as depicted in first schematic 2800A the preform 2840 is shown mounted to left translation stage 2860 and right translation stage 2850 which are capable of independent motion at different speeds if required and as established from the carving sequences, such as first to third carving sequences discussed above in respect of FIG. 27. Also shown is a heater 2870 in first configuration mounted to heater stage 2880. The preform comprising a core 2810, cladding 2820 and coating 2830.

Next in second schematic 2800B the manufacturing sequence is shown after the execution of the first carving sequence wherein the preform 2840 now comprises left section 2841, right section 2842 and central portion 2842, which for example may be of constant diameter 125 μm. With the reduction in diameter of the central portion 2840 the heating element may be positioned at a new position, depicted by shifted heater 2872. Next in third schematic 2800C the micro-taper is shown after the execution of the second and third carving sequences wherein the preform 2840 now comprises left section 2844, right section 2845, input 2846, output 2847, input transition 2848 and output transition 2849 with no wire portion in this exemplary schematic. At this point the manufactured optical fiber with fiber taper/micro-taper may be removed from the carving system wherein the optical fiber with fiber taper/micro-taper is cleaved through each of the input 2846 and output 2847 allowing these ends to then be spliced/fused to the optical fibers that will couple to the optical component.

It would be evident that right section 2845 may be a very small portion of the preform if the first carving stage is executed close to one end of the preform rather than in the middle as shown in the exemplary manufacturing sequence of FIG. 28. For example, whilst the preform may be physically clamped at the left hand side in the schematics shown a glass rod may be fused to the right hand end of the preform to be mounted to the right translation stage 2860 thereby reducing the amount of preform wasted during the first carving sequence. Optionally, according to the constraints of cost, time, performance, etc the number of carving steps in each of the first to third carving sequences may be varied as well as the number of carving sequences may be varied. Accordingly, the generation of the carving sequence as discussed above in respect of the “Multi-Sweep Tapering” or “Generalized Heat Brush Method” may be made with varying parameters.

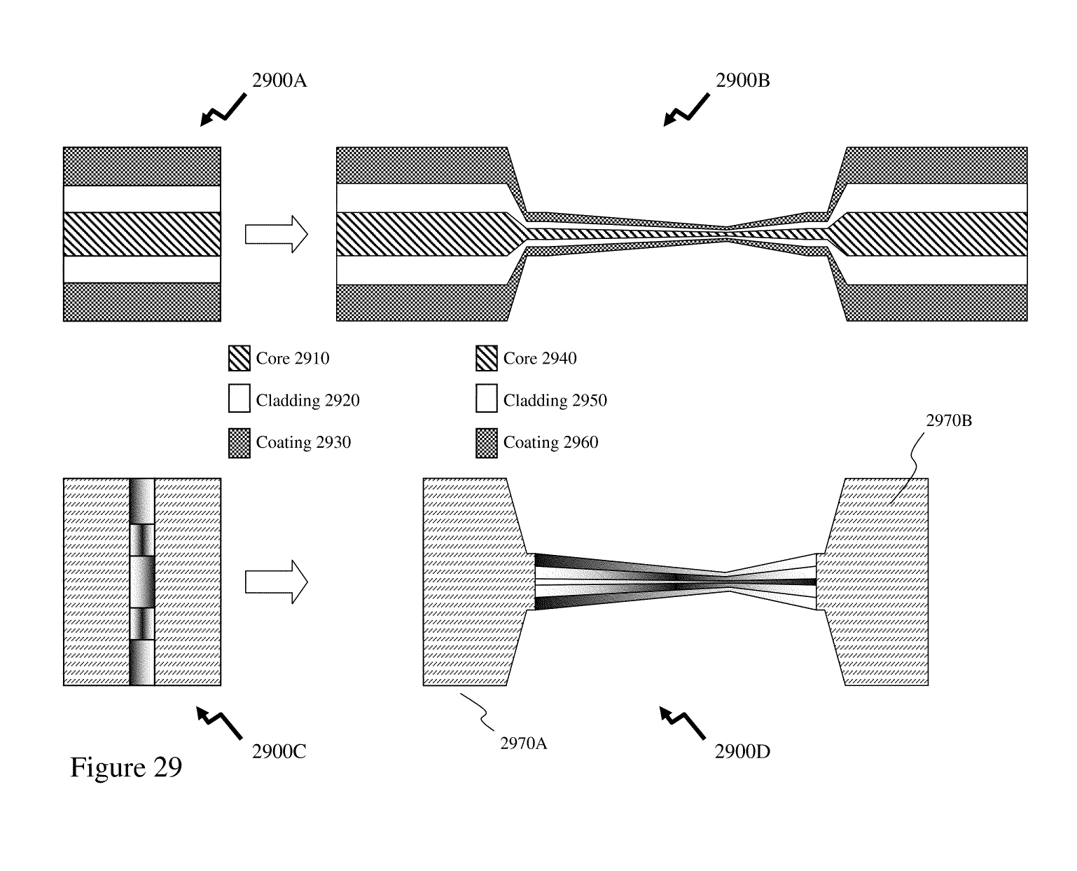

Referring to FIG. 29 there are depicted integrated optical fiber/micro-taper designs according to embodiments of the invention wherein first and second preforms 2900A and 2900C respectively are longitudinally uniform and non-uniform respectively resulting in first and second integrated optical fiber/micro-taper designs 2900B and 2900D respectively. Accordingly, first preform 2900A comprises first core 2910, first cladding 2920 and first coating 2930 which are of uniform characteristics along the length of the first preform 2900A such that when an optical fiber/micro-taper 2900B is carved each of the resulting extruded first core 2910/first cladding 2920/first coating 2930 are uniform in properties along the length of the optical fiber/micro-taper 2900B.

In contrast, second preform 2900C comprises second core 2940, second cladding 2950 and second coating 2960 which are of non-uniform characteristics along the length of the second preform 2900C. Second core 2910 varying as shown left to right in a characteristic, as depicted visually by the changing grayscale. Second coating 2960 similarly varies from left to right in a characteristic, as depicted visually by the changing grayscale. Second cladding 2950 in contrast varies from left to the middle and then varies in reverse fashion to the right such that the maximum change in the characteristic is in the middle of the preform section from which the integrated optical fiber/micro-taper will be formed. As such when second preform 2900C is carved each of the resulting extruded second core 2940/second cladding 2950/second coating 2960 vary in their in properties along the length of the integrated optical fiber/micro-taper 2900D according to their initial distributions. Further each end of the carved structure includes first and second regions 2970A and 2970B which as they are not going to form any part of the integrated optical fiber/micro-taper 2900D may be materials selected based upon different criteria to those of second core 2940, second cladding 2950 and second coating 2960. In essence these first and second regions 2970A and 2970B are sacrificial.

It would be evident that second preform 2900C may lend itself to different planar deposition and manufacturing methodologies and materials selection. For example, second cladding 2620 may allow low insertion losses at the optical fiber interface to SMF-28, for example, to be achieved as it is undoped whereas at doping levels commensurate with the desired properties in the non-linear micro-taper and wire such a low-loss interface cannot be achieved. Accordingly, the methodology presented allows novel fiber geometries to be manufactured and formed into optical devices in a manner not achievable with the prior art approach of drawing an optical fiber and then forming the fiber taper/micro-taper. In many instances the region comprising second core 2940, second cladding 2950 and second coating 2960 would be visually distinct from the material that forms first and second regions 2970A and 2970B allowing positioning of the second preform 2900C within the carving system. Alternatively, the second preform 2900C may specifically include an additional layer at the interfaces to the “sacrificial” regions for increased ease of locating the second core 2940, second cladding 2950 and second coating 2960.

It would be evident to one skilled in the art that other fiber designs other than those depicted within Figures may be employed without departing from the scope of the invention.

It would be evident to one skilled in the art that optionally the carving sequence may be also distributed between two or more machines without departing from the scope of the invention. For example, a first system may be used to perform the first carving to generate the optical fiber from the preform and a second system used to execute the remaining carving to generate the fiber taper/micro-taper. As discussed above the position of the heater may be adjusted between carving the larger preform and carving the reduced diameter optical fiber. It would also be evident that the heater may swapped out between these carving steps allowing for example the length of the heating element, and accordingly the hot-zone, to be adjusted between different carving sequences. It would also be possible to adjust the heating between each individual carving sweep, for example by dynamically controlling an array of heating elements or adjusting the diameter and power of a laser impinging on the optical preform/optical fiber/fiber-taper/micro-taper.

Within the embodiments described above the optical components have generally been described in terms of transmissive components for use within an optical fiber system. However, it would be evident to one skilled in the art that alternative designs may be employed without departing from the scope of the invention wherein the optical fiber/fiber taper/micro-taper are employed with a transmitter and/or receiver directly. In such instances the fabricated optical fiber/fiber taper/micro-taper may be cleaved at a predetermined location within the fiber taper/micro-taper as well as the optical fiber. Further the cleaved fiber taper/micro-taper end may be further processed, for example through a reflow process to form a lens at the tip of the micro-taper.

It would also be evident to skilled in the art that whilst the specification in terms of background and description have been presented with respect to telecommunications that the invention may also be applied to optical fiber structures within other fields including, but not limited to, instrumentation, optical sources, and biomedicine.

The methodologies described herein are, in one or more embodiments, performable by a machine which includes one or more processors that accept code segments containing instructions to perform or implement a method of designing and/or manufacturing. For any of the methods described herein, when the instructions may be or are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth. The term memory as used herein refers to any non-transitory tangible computer storage medium.

The memory includes machine-readable code segments (e.g. software) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be a computer or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The above-described embodiments of the present invention are intended to be examples only. Alterations, modifications and variations may be effected to the particular embodiments by those of skill in the art without departing from the scope of the invention, which is defined solely by the claims appended hereto.

1. (canceled)

2. (canceled)

3. (canceled)

4. (canceled)

5. (canceled)

6. (canceled)

7. A device comprising:
an optical fiber comprising a first section of a first length and a first diameter; wherein,
the device is manufactured using a process comprising executing a carving sequence comprising a predetermined subset of carving profiles of a plurality of carving profiles in order to fabricate the device from an optical preform.

8. The device according to claim 7 wherein,
the carving sequence is generated by a process comprising:
a) receiving at least a preform characteristic of a plurality of preform characteristics relating to a geometry of the optical preform;
b) receiving a plurality of fiber characteristics relating to the geometry of the optical fiber; and
c) generating the carving sequence comprising at least one carving profile of a plurality of carving profiles in dependence upon at least the preform characteristic and the plurality of fiber characteristics.

9. The device according to claim 7 further comprising;
a second section the optical fiber characterized by a second length and a second diameter; and
an optical fiber transition comprising a first transition of a first transition length transitioning from the first diameter to a minimum transition diameter and a second transition of a second transition length transitioning from the minimum transition diameter to the second diameter.

10. The device according to claim 8 wherein,
step (b) of the process for generating the carving sequence comprises;
receiving the first length, the second length, the first diameter, the second diameter, the minimum transition diameter, the first transition length and the second transition length as the plurality of fiber characteristics relating to the geometry of the optical fiber.

11. The device according to claim 7 wherein,
step (c) generates:
at least one mount displacement characteristic of a plurality of mount displacement characteristics, each mount displacement characteristic relating to a translation stage coupled to the optical preform; and
generates at least one heater characteristic of a plurality of heater displacement characteristics, each heater displacement characteristic relating to a heater translation stage to which a heater is mounted.

12. The device according to claim 9 wherein,
the first transition length and the second transition length are not equal even when the first diameter and the second diameter are equal.

13. The device according to claim 7 further comprising;
an optical fiber transition comprising a first transition of a first transition length transitioning from the first diameter to a minimum transition diameter and a second transition of a second transition length transitioning from the minimum transition diameter to a second diameter.

14. (canceled)

15. (canceled)

16. (canceled)

17. (canceled)

18. (canceled)

19. (canceled)

20. The device according to claim 7 wherein,
the optical fiber comprises after the first section a first transition from an initial diameter of the optical fiber to the first diameter, a second transition from the first diameter to the initial diameter of the optical fiber, and a second section of a second length and the first diameter, each of the first and second transitions comprising a plurality of transition sections defined by a final diameter at the end of the respective transition section and a length of the respective transition section.

21. The device according to claim 13 wherein,
the first and second transitions have differing profiles of outer diameter versus distance along the transition.

22. The device according to claim 20 wherein,
the first and second transitions have differing profiles of outer diameter versus distance along the transition.

23. The device according to claim 7 wherein,
the diameter of the optical preform is larger than the first diameter.

24. The device according to claim 7 wherein,
the predetermined subset of carving profiles of the plurality of carving profiles were generated in dependence upon at least the outer diameter of the optical preform, the first length, and the first diameter.

25. The device according to claim 13 wherein,
the predetermined subset of carving profiles of the plurality of carving profiles were generated in dependence upon at least the outer diameter of the optical preform, the first length, the first diameter, the first transition, and the second transition.
